(19) United States
(12) Patent Application Publication
(10) Pub. No.: US 2026/0364458 A1
(43) Pub. Date: Nov. 19, 2026

(54) VIRTUAL OBJECT CONTROL METHOD AND APPARATUS, DEVICE, AND STORAGE MEDIUM

(71) Applicant: Tencent Technology (Shenzhen) Company Limited, Shenzhen (CN)

(72) Inventor: Xiusheng Song, Shenzhen (CN)

(21) Appl. No.: 19/739,976

(22) Filed: Jul. 13, 2026

Related U.S. Application Data
(63) Continuation of application No. PCT/CN2025/127809, filed on Oct. 15, 2025.

(30) Foreign Application Priority Data
Oct. 31, 2024 (CN) 202411548436.4

(51) Int. Cl. A63F 13/56; A63F 13/533; A63F 13/822

(52) U.S. Cl. CPC A63F 13/56; A63F 13/533; A63F 13/822; A63F 2300/308; A63F 2300/638

(57) ABSTRACT

This application discloses a virtual object control method performed by a computer device. The method includes: displaying a graphical user interface of a virtual environment, the virtual environment comprising a virtual object and a virtual pet; receiving a first trigger operation on a capture control of the graphical user interface for the virtual pet, the first trigger operation being a continuous press operation configured for generating consecutive capture operations for the virtual pet; determining a quantity of capture operations generated by the first trigger operation based on a press duration of the continuous press operation; and controlling the virtual object to perform consecutive capture operations for the virtual pet until after the virtual pet is successfully captured by the virtual object or the quantity of capture operations generated by the first trigger operation is exhausted by the virtual object.

### CROSS-REFERENCE TO RELATED APPLICATIONS

This application is a continuation application of PCT Patent Application No. PCT/CN2025/127809, entitled “VIRTUAL OBJECT CONTROL METHOD AND APPARATUS, DEVICE, AND STORAGE MEDIUM” filed on Oct. 15, 2025, which claims priority to Chinese Patent Application No. 202411548436.4, entitled “VIRTUAL OBJECT CONTROL METHOD AND APPARATUS, DEVICE, AND STORAGE MEDIUM” filed on Oct. 31, 2024, both of which are incorporated herein by reference in their entirety.

### FIELD OF THE TECHNOLOGY

This application relates to the field of computer technologies, and in particular, to a virtual object control method and apparatus, a device, and a storage medium.

### BACKGROUND OF THE DISCLOSURE

In most games, if a user wants to own a pet in the game, the user needs to control a virtual object to capture a virtual pet. When the virtual pet is successfully captured, the virtual pet becomes a pet of the virtual object.

In the related art, when controlling the virtual object to capture the virtual pet, it is required to perform an operation for a capture control. For example, each time an operation for the capture control is performed, the virtual pet is controlled to be captured once. If the virtual pet is not successfully captured, an operation for the capture control is performed again, and the virtual pet is controlled to be captured once again until the virtual pet is captured.

However, in the related art, each capture of the virtual pet corresponds to one operation for the capture control. To be specific, capturing the virtual pet each time requires separately triggering the capture control. The user needs to repeatedly perform multiple operations. The repetitiveness of operations in this process directly leads to increased time cost. Moreover, intervals between multiple operations may reduce capture continuity, and the efficiency of capturing the virtual pet is low.

### SUMMARY

Embodiments of this application provide a virtual object control method and apparatus, a device, and a storage medium, to improve efficiency of capturing a virtual pet. The technical solutions provided in the embodiments of this application are as follows:

Embodiments of this application provide a method for controlling a virtual object to capture virtual pets in a virtual environment performed by a computer device. The method includes:

displaying a graphical user interface of a virtual environment, the virtual environment comprising a virtual object and a virtual pet;

receiving a first trigger operation on a capture control of the graphical user interface for the virtual pet, the first trigger operation being a continuous press operation configured for generating consecutive capture operations for the virtual pet;

determining a quantity of capture operations generated by the first trigger operation based on a press duration of the continuous press operation; and

controlling the virtual object to perform consecutive capture operations for the virtual pet until after the virtual pet is successfully captured by the virtual object or the quantity of capture operations generated by the first trigger operation is exhausted by the virtual object.

Embodiments of this application provide a computer device. The computer device includes a processor and a memory. The memory has a computer program stored therein. The computer program is loaded and executed by the processor to cause the computer device to implement the foregoing virtual object control method.

Embodiments of this application provide a non-transitory computer-readable storage medium. The computer-readable storage medium has a computer program stored therein. The computer program is loaded and executed by a processor of a computer device and causes the computer device to implement the foregoing virtual object control method.

The embodiments of this application may have the following beneficial effects:

In view of the problem of low capture efficiency caused by performing an operation for a capture control during each capture in the related art, according to the technical solutions provided in the embodiments of this application, a single operation (e.g., first trigger operation) for the capture control can generate consecutive capture operations for a virtual pet. In addition, a success probability of each capture exists independently (less than 1). This manner reduces user interactions from the operation source. Users do not need to perform a separate trigger action for each capture, and can start a consecutive capture procedure through a single operation. Accordingly, multiple trigger operations in the related art are simplified to a single trigger operation, which reduces operation burden and operation time consumption of users. Meanwhile, the continuity of consecutive capture avoids efficiency losses caused by intervals between single operations, so that more capture attempts can be completed within the same period of time. Finally, without changing the success probability of a single capture, this application does not require performing multiple operations on the capture control. By optimizing operation logic and simplifying the operations, the efficiency of capturing the virtual pet is improved.

### BRIEF DESCRIPTION OF THE DRAWINGS

FIG. 1 is a schematic diagram of a solution implementation environment according to an embodiment of this application.

FIG. 2 is a schematic diagram of a virtual pet capture method in the related art.

FIG. 3 is a flowchart of a virtual object control method according to an embodiment of this application.

FIG. 4 is a flowchart of a virtual object control method according to an embodiment of this application.

FIG. 5 is a flowchart of a virtual object control method according to an embodiment of this application.

FIG. 6 is a schematic diagram of crosshair and capture probability according to an embodiment of this application.

FIG. 7 is a schematic diagram of one capture operation according to an embodiment of this application.

FIG. 8 is a schematic diagram of countdown reduction according to an embodiment of this application.

FIG. 9 is a schematic diagram during execution of a first trigger operation according to an embodiment of this application.

FIG. 10 is a schematic diagram of a quantity of trigger operations according to an embodiment of this application.

FIG. 11 is a schematic diagram of refreshing of duration indication information according to an embodiment of this application.

FIG. 12 is a schematic diagram of different postures of a virtual object throwing capture props according to an embodiment of this application.

FIG. 13 is a schematic diagram of at least one capture operation according to an embodiment of this application.

FIG. 14 is a schematic diagram of continuous reduction of a quantity of capture operations according to an embodiment of this application.

FIG. 15 is a schematic diagram of successful capture of a virtual pet according to an embodiment of this application.

FIG. 16 is a schematic diagram of return of a capture prop according to an embodiment of this application.

FIG. 17 is a schematic diagram of a virtual pet capture procedure according to an embodiment of this application.

FIG. 18 is a block diagram of a virtual object control apparatus according to an embodiment of this application.

FIG. 19 is a structural block diagram of a terminal device according to an embodiment of this application.

### DESCRIPTION OF EMBODIMENTS

To make the objectives, technical solutions, and advantages of this application clearer, the following further describes implementations of this application in detail with reference to the accompanying drawings.

Before the embodiments of this application are described, for ease of understanding this solution, terms appearing in this solution are explained below.
1. Virtual Environment: An environment displayed (or provided) when an application runs on a terminal device. The virtual environment may be a simulated world of a real world, a three-dimensional world that is partially simulated and partially fictional, or a purely fictional three-dimensional world. The virtual environment may be any one of a two-dimensional virtual environment, a 2.5-dimensional virtual environment, or a three-dimensional virtual environment. In some embodiments, the virtual environment is further configured for virtual environment battles between at least two virtual characters, and the virtual environment is provided with virtual resources available for use by the at least two virtual characters. In some embodiments, the virtual environment includes freely movable virtual pets, and a virtual object may independently select a virtual pet to be captured.
2. Virtual Object: A movable object or an immovable object in a virtual scene. The movable object may be at least one of a virtual person, a virtual animal, and an animated character. The immovable object may be at least one of a virtual building, a virtual plant, and a virtual terrain. In some embodiments, when the virtual scene is a three-dimensional virtual scene, the virtual object may be a three-dimensional virtual model. Each virtual object has a shape and a volume in the three-dimensional virtual scene, and occupies a part of space in the three-dimensional virtual scene. In some embodiments, the virtual object is a three-dimensional character constructed based on a three-dimensional human skeleton technology. The virtual object presents different external appearances by wearing different skins. In some implementations, the virtual object may alternatively be implemented with a 2.5-dimensional or 2-dimensional model. This is not limited in the embodiments of this application. The virtual object may be divided into a user-controlled virtual object and a server-controlled virtual object based on different control modes for virtual objects. The user-controlled virtual object is a client-controlled movable object in the virtual scene. The server-controlled virtual object is a virtual object controlled by an automatic control algorithm or an artificial intelligence (AI) program on a client or a server. The server-controlled virtual object includes a movable object and an immovable object in the virtual scene. The immovable object may respond to or affect activities of the movable object. For example, the movable object may destroy the immovable object. Alternatively, when the movable object enters the immovable object, the movable object enters an invisible state.
3. Virtual Character: A movable user-controlled virtual object in a client of an application. The virtual character may be at least one of a virtual person, a virtual animal, and an animated character. In some embodiments, when the virtual scene is a three-dimensional virtual scene, the virtual character may be a three-dimensional virtual model. Each virtual character has a shape and a volume in the three-dimensional virtual scene, and occupies a part of space in the three-dimensional virtual scene. In some embodiments, the virtual character is a three-dimensional character constructed based on a three-dimensional human skeleton technology. The virtual character presents different external appearances by wearing different skins. In some implementations, the virtual character may alternatively be implemented with a 2.5-dimensional or 2-dimensional model. This is not limited in the embodiments of this application.
4. Virtual Pet: A movable virtual object owned by a virtual character. The virtual pet may be controlled by a user via a client, or controlled by an automatic control algorithm or an AI program on the client or a server. Therefore, part of behaviors of the virtual pet are controlled by the user via the client, and the other part of behaviors are controlled by the automatic control algorithm or the AI program on the client or the server. The user may manage at least one virtual pet owned by the user-controlled virtual character. For example, the user issues instructions to the virtual pet in the client, so that the virtual pet may execute tasks corresponding to the instructions, including but not limited to combat, construction, farm work, and industrial production. The virtual pet may execute relevant tasks including but not limited to combat, construction, farm work, and industrial production based on the automatic control algorithm or the AI program on the client or the server, and may also implement capabilities such as controlling virtual objects. The virtual pet may be a virtual object designed based on real animals, a virtual object designed based on animated characters, or a virtual object independently designed by technical personnel. In some embodiments, when the virtual scene is a three-dimensional virtual scene, the virtual pet may be a three-dimensional virtual model. Each virtual pet has a shape and a volume in the three-dimensional virtual scene, and occupies a part of space in the three-dimensional virtual scene. In some embodiments, the virtual pet is a three-dimensional object constructed based on a three-dimensional skeleton technology. The virtual pet may present different external appearances by wearing different skins. In some implementations, the virtual pet may alternatively be implemented with a 2.5-dimensional or 2-dimensional model. This is not limited in the embodiments of this application.
5. Non-player Character: A virtual object controlled by an automatic control algorithm or an AI program on a client or a server. The non-player character may be at least one of a virtual person, a virtual animal, a virtual pet, and an animated character. In some embodiments, when the virtual scene is a three-dimensional virtual scene, the non-player character may be a three-dimensional virtual model. Each non-player character has a shape and a volume in the three-dimensional virtual scene, and occupies a part of space in the three-dimensional virtual scene. In some embodiments, the non-player character is a three-dimensional character constructed based on a three-dimensional human skeleton technology. The non-player character presents different external appearances by wearing different skins. In some implementations, the non-player character may alternatively be implemented with a 2.5-dimensional or 2-dimensional model. This is not limited in the embodiments of this application. For example, the non-player character is a virtual pet.
6. User Interface (UI) Control: Any visible control or element on a UI of an application, such as a picture, an input box, a text box, a button, or a tag, where some UI controls respond to user operations. For example, a capture control is configured to capture a virtual pet. A user presses the capture control to capture the virtual pet. The UI control involved in the embodiments of this application include but is not limited to the capture control.

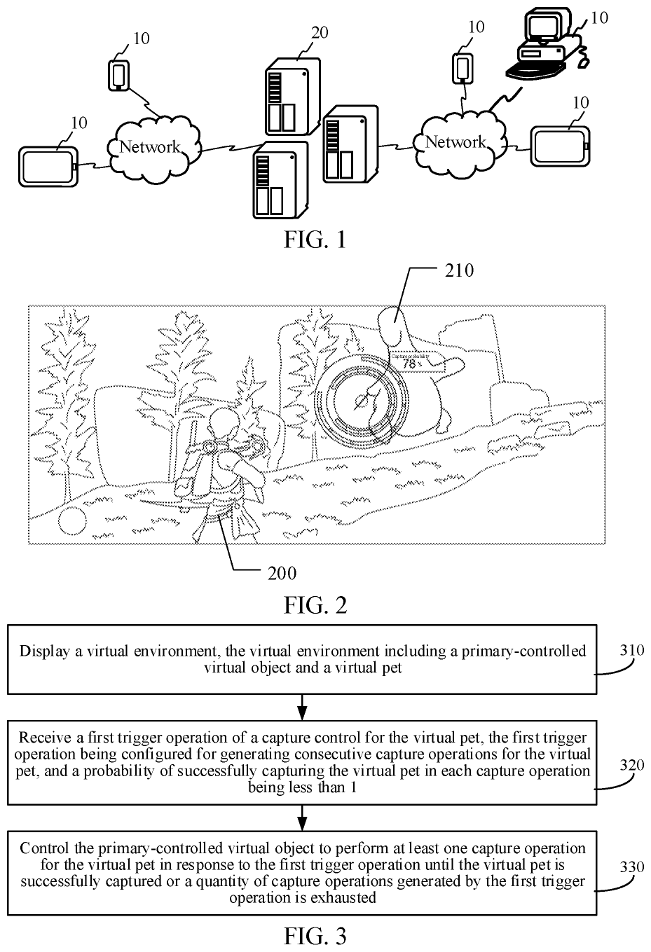

FIG. 1 shows a schematic diagram of a computer system according to an embodiment of this application. The computer system may be implemented as a virtual object control system. The computer system may include: a terminal device 10 and a server 20.

One or more terminal devices 10 may be provided. The terminal device 10 may be an electronic device such as a mobile phone, a tablet computer, a game console, an e-book reader, a multimedia playback device, a wearable device, a personal computer (PC), or a vehicle-mounted terminal. A client of a target application (e.g., a game application) may be installed in the terminal device 10. In some embodiments, the target application may be an application that needs to be downloaded and installed, or may be a click-to-use application. This is not limited in the embodiments of this application.

In the embodiments of this application, the target application is an application provided with a virtual pet. The target application may be any one of a simulation program, a shooting game, a virtual reality (VR) application, an augmented reality (AR) program, a three-dimensional map program, a VR game, an AR game, a first-person shooting (FPS) game, a multiplayer gunfight survival game, a third-person shooting (TPS) game, a multiplayer online battle arena (MOBA), a simulation game (SLG), a social application, and an interactive entertainment application. In addition, different applications provide virtual characters and virtual pets with different forms, shapes, and corresponding skills. This is not limited in the embodiments of this application. In some embodiments, the client of the foregoing application is run on the terminal device 10. In some embodiments, the foregoing application is developed based on a three-dimensional virtual scene engine. For example, the virtual scene engine is a Unity engine. The virtual scene engine can construct a three-dimensional virtual scene, a virtual object, a virtual prop, and the like, so as to bring users a more immersive gaming experience.

The foregoing virtual scene refers to a constructed scene where a virtual object and a virtual pet carry out activities (e.g., game competitions), for example, a virtual house, a virtual island, and a virtual map.

The foregoing virtual object refers to a virtual character, a virtual vehicle, a virtual article, or the like controlled by a user account in a target application. This is not limited in the embodiments of this application. In an example where the target application is a game application, the virtual object refers to a game object controlled by a user account in the game application. The virtual object may be in a person form, an animal form, a cartoon form, or other forms. This is not limited in the embodiments of this application. The virtual object in this application is a virtual object controlled by the client. The virtual object in this application is a virtual object controlled by the client, and the virtual pet may be a virtual object controlled by the server.

The server 20 is configured to provide background services for the client of the target application installed in the terminal device 10. For example, the server 20 may be, but is not limited to, an independent physical server, or a server cluster or a distributed system including a plurality of physical servers, or a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform.

The terminal device 10 and the server 20 may communicate with each other via a network. The network may be a wired network or a wireless network.

Prior to introducing specific solutions of this application, brief descriptions of the related art are provided as follows.

In the related art, as shown in FIG. 2, a player presses a capture control to bring up an aiming crosshair. The player aligns the aiming crosshair with a unit to be captured, then releases or clicks/taps the capture control to control a virtual object 200 to throw out a capture prop. After the capture prop flies in the air or rolls on the ground for a certain distance, capture is initiated if the capture prop hits a target (i.e., target pet) 210. If the target is not hit, the capture fails and the capture prop is consumed. When the player intends to continue capturing after the capture fails, the player needs to repeatedly perform the above procedure until the capture succeeds.

The related art has at least the following drawbacks. 1. Low Efficiency: When the player needs to capture the target pet repeatedly, the capture prop and a capture control trigger operation are required for each capture, which increases time costs and operation complexity of the game. 2. Repetitive Work: The repetition of the same capture actions tends to make the player feel monotonous and tedious, and reduces the fun of the game. 3. Frequent Prop Consumption: The frequent consumption of the capture prop requires the player to constantly replenish inventory. In addition, the player cannot accurately predict a quantity of props consumed in multiple captures. 4. Poor Experience: Each capture may fail, and consecutive failures will seriously dampen the enthusiasm and gaming experience of the player. 5. Lack of Strategy: Simple repetitive operations have no depth and strategic elements, so that the player can hardly raise the capture success rate by means of skills or strategies. 6. Single Mode: Most current games only support one fixed capture mode, and lack diverse and personalized capture manners. 7. Heavy Server Load: A large number of consecutive capture requests may impose heavy load on a game server and affect game stability and response speed.

In view of the foregoing drawbacks existing in the related art, the problems to be solved by this application are set forth as follows. 1. Operation Simplification: By continuously pressing a button or a mouse, the player may use the capture prop continuously in a single operation, which reduces a quantity of repeated operations. 2. Efficiency Improvement: A new consecutive capture manner improves capture efficiency and enables the player to complete multiple captures within a shorter period of time. 3. Game Presentation Improvement: Different action performances and feedback mechanisms are introduced to deliver fresh visual and sensory experiences for each capture, so as to increase the fun and appeal of the game. 4. Player Resource Management: The capture prop is still consumed, yet the consecutive capture manner allows the player to use and manage resources in a more planned manner and avoids waste. 5. Server Load Optimization: Each capture requires transmission of relevant data (e.g., a pet state and prop usage information), consecutive capture enables integrated transmission of such data. 6. Great Potential for Diversified Expansion: The consecutive capture mechanism supports addition of various capture effects and animation performances in the game. The player may select the most appropriate capture rhythm and strategies based on characteristics of different pets. Specifically, the technical solutions provided in the embodiments of this application will be explained in detail in combination with the following embodiments. Details are not described again herein.

FIG. 3 shows a flowchart of a virtual object control method according to an embodiment of this application. Operations of the method may be performed by the terminal device 10 in the computer system shown in FIG. 1. For example, the operations may be performed by the client of the foregoing target application. In the following method embodiments, for ease of description, the operations are performed only by the “client”. The method may include at least one of the following operations (310 to 330).

Operation 310: Display a virtual environment, the virtual environment including a virtual object and a virtual pet. In some embodiments, the computer device displays a graphical user interface of the virtual environment on a screen as depicted in the figures described below and the virtual environment includes a virtual object and a virtual pet. The virtual object is controlled by a user of the computer device as a virtual character in the virtual environment.

In the embodiments of this application, there are at least three display manners for displaying the virtual environment on a terminal device. The first manner is FPS. To be specific, a virtual camera is installed at the head of the virtual object, and images captured by the virtual camera viewing the virtual environment are used as presentation images of the displayed virtual environment. At this time, the images of the displayed virtual environment do not include the virtual object. The second manner is TPS. To be specific, a virtual camera is installed behind the virtual object, and images captured by the virtual camera viewing the virtual environment are used as images of the displayed virtual environment. At this time, the images of the displayed virtual environment may include the partial or entire virtual object. The orientations of both FPS and TPS change along with the orientation of the virtual object. The third manner is another perspective in a specific direction. The orientation of the perspective will not change along with the orientation of the virtual object. To be specific, images captured by the virtual camera viewing the entire virtual environment in a specific direction are used as presentation images of the displayed virtual environment. At this time, the virtual object may be displayed at the center of the presentation images of the virtual environment, at other positions of the presentation images of the virtual environment, or not displayed in the presentation images of the virtual environment. This is not limited in this application. The virtual environment in the embodiments of this application may be at least one of a three-dimensional virtual environment, a two-dimensional virtual environment, and a 2.5-dimensional virtual environment. This is not limited in this application.

The virtual object mentioned in the embodiments of this application refers to a virtual object controlled by a user account in a client of a target application (e.g., game application). The client of the target application is installed on the foregoing terminal device. In some embodiments, the terminal device 10 shown in FIG. 1 includes a first terminal device and a second terminal device. A first client of a target application is installed on the first terminal device, and a second client of the target application is installed on the second terminal device. A first user account of a first user controls a first virtual object (also referred to as a virtual object) in the first client of the target application. A second user account of a second user controls a second virtual object in the second client of the target application. It is clear that the second virtual object in the embodiments of this application may be the foregoing user-controlled virtual object, or a server-controlled virtual object (AI virtual object). The first virtual object and the second virtual object may exist in the same virtual environment. The first virtual object and the second virtual object may belong to the same camp, the same team, or the same organization, have a friend relationship with each other, or have a temporary communication permission. At this time, the second virtual object may be regarded as an ally virtual object of the first virtual object. The first virtual object and the second virtual object may alternatively belong to different camps, different teams, or different organizations, or have an adversarial relationship. At this time, the second virtual object may be regarded as an enemy virtual object of the first virtual object. The clients installed on the first terminal device and the second terminal device may be identical, or the clients installed on the first terminal device and the second terminal device are clients of the same type on different operating system platforms (i.e., Android or IOS). The first terminal device may refer to one of a plurality of terminal devices, and the second terminal device may refer to another one of the plurality of terminal devices. In this embodiment, only the first terminal device and the second terminal device are used as an example for description.

In some embodiments, the virtual environment includes a virtual pet. The virtual pet mentioned in the embodiments of this application refers to another virtual object different from the virtual object in the virtual environment. In some embodiments, the virtual pet may be the foregoing second virtual object. The virtual pet may be a user-controlled virtual object or a server-controlled virtual object. This is not limited in this application. When the virtual pet is a user-controlled virtual object, the virtual object may capture another user-controlled virtual object and take the captured another user-controlled virtual object as a pet. When the virtual pet is a server-controlled virtual object, the virtual object may capture an AI virtual object controlled by the server based on a preset algorithm in the virtual environment as a pet. After the virtual pet becomes the pet of the virtual object, the virtual pet is controlled by the virtual object or by a user account that controls the virtual object.

The quantity, shape, position, and the like of the virtual pet are not limited in the embodiments of this application. The virtual pet is a movable object or an immovable object in the virtual environment.

Operation 320: Receive a first trigger operation on a capture control for the virtual pet, the first trigger operation being configured for generating consecutive capture operations for the virtual pet, and a probability of successfully capturing the virtual pet in each capture operation being less than 1.

In some embodiments, the capture control is a UI control. In some embodiments, the capture control is always displayed on a UI. In some embodiments, the capture control is displayed on the UI when a distance between the virtual object and the virtual pet is less than or equal to a first threshold. The first threshold is a preset value. In some embodiments, the capture control is displayed in response to a click/tap operation for a capture prop (see the description below).

In some embodiments, the capture control is not displayed on the UI all the time. The capture control is displayed in response to a press operation. The capture control is displayed at a press position of the press operation. A center point of the capture control coincides with the press position of the press operation.

In some embodiments, the “displaying the capture control in response to a press operation” may refer to displaying the capture control in response to a press operation directly applied to a screen of the terminal device, or displaying the capture control in response to an operation for an external device of the terminal device. The external device of the terminal device refers to a device directly or indirectly connected to the terminal device. The external device of the terminal device includes but is not limited to at least one of a mouse, a game controller, and a touch screen. The “displaying the capture control in response to a press operation” may refer to displaying the capture control in response to an operation for the mouse (e.g., a click/tap operation, a press operation, and a press-and-hold operation), displaying the capture control in response to an operation for the game controller (e.g., a click/tap operation, a press operation, and a press-and-hold operation), or displaying the capture control in response to an operation for the touch screen (e.g., a click/tap operation, a press operation, and a press-and-hold operation).

In some embodiments, operations for the external device of the terminal device may be defined as the first trigger operation, in addition to operations directly for the capture control displayed on the screen of the terminal device. The operation for the external device of the terminal device is deemed as the first trigger operation for the capture control. The operation for a joystick of the game controller is deemed as the first trigger operation for the capture control. The operation for the mouse is deemed as the first trigger operation for the capture control. The operation for the touch screen is deemed as the first trigger operation for the capture control.

The first trigger operation mentioned in the embodiments of this application may be a single operation where a finger (or another part in contact with the device) does not leave the device. The press-and-hold operation performed by a user's finger on the capture control is deemed as the first trigger operation. The press-and-hold operation performed by a user's finger on the joystick of the game controller is deemed as the first trigger operation. The press-and-hold operation performed by a user's finger on at least one of a left mouse button, a right mouse button, or a mouse scroll wheel is deemed as the first trigger operation. The press-and-hold operation performed by a user's finger on the touch screen is deemed as the first trigger operation.

In some embodiments, the first trigger operation ends when the user's finger (or another part in contact with the device) leaves the device.

In some embodiments, the first trigger operation triggers consecutive capture operations for the virtual pet. A quantity of capture operations is determined based on operation duration of the first trigger operation. The quantity of capture operations is determined based on an operation position of the first trigger operation. The quantity of capture operations is determined based on an operation pressure of the first trigger operation. Specifically, for details, refer to the description of the following embodiments. Details are not described again herein.

In some embodiments, each capture operation does not necessarily result in successful capture of the virtual pet. The probability of successfully capturing the virtual pet in each capture operation is less than 1. In some embodiments, each capture operation requires a certain operation duration to be completed. The probability of successfully capturing the virtual pet in each capture operation is a preset probability value. The probability of successfully capturing the virtual pet varies for each capture operation.

Operation 330: Control the virtual object to perform at least one capture operation on the virtual pet in response to the first trigger operation until the virtual pet is successfully captured or a quantity of capture operations generated by the first trigger operation is exhausted.

In some embodiments, after the first trigger operation ends, the virtual object is controlled to perform at least one capture operation on the virtual pet.

In some embodiments, it is supposed that the quantity of capture operations generated by the first trigger operation is K, where K is an integer greater than 1. After the first trigger operation ends, the virtual object is entitled to K capture operations. After the first trigger operation ends, the virtual object is controlled to perform capture operations automatically. The virtual object starts to perform a first capture operation on the virtual pet. When the virtual pet is successfully captured in the first capture operation, no subsequent capture operations will be performed. When the virtual pet is not successfully captured in the first capture operation, the virtual object is controlled to perform a second capture operation on the virtual pet until the virtual pet is successfully captured. It is possible that the virtual pet is successfully captured in the first capture operation among the K capture operations. It is also possible that all K capture operations are exhausted without successful capture of the virtual pet.

In some embodiments, the at least one capture operation performed by the virtual object for the virtual pet in the embodiments of this application is executed in sequence. There is no time interval between two adjacent capture operations, or the time interval is less than a duration threshold. The duration threshold refers to an upper limit of time ensuring that users cannot perceive an interval between the two capture operations. Specifically, it may be determined based on the persistence of vision of human eyes (100-150 milliseconds) and conventional game interaction design (50-100 milliseconds), while considering the data processing capability of the terminal device. For example, the duration threshold may be set within 100 milliseconds. This threshold avoids perceptual discontinuity of users caused by an excessively long interval, and avoids system performance issues caused by an excessively short interval. If the virtual pet is not successfully captured after the previous capture operation ends, the next capture operation starts automatically. By contrast, in the related art, users need to click/tap the capture control again to initiate the next capture operation after one capture operation ends. Since user clicks/taps on the capture control and responses from the terminal device, the server, and other devices all take time, the second capture operation in the related art definitely starts later than the automatically executed second capture operation in this application. Therefore, this application can reduce time consumed for multiple capture operations and improve capture efficiency.

The implementation manner of the capture operations is not limited in the embodiments of this application. The virtual pet can be captured by means of a capture prop. The virtual pet can be captured by the virtual object, for example, by controlling the virtual object to release capture skills. The virtual pet can be captured by the virtual object placing traps. In the following embodiments of this application, the implementation of capture operations using capture props will be taken as the main example for illustration.

According to the technical solutions provided in the embodiments of this application, in view of the problem of low capture efficiency caused by performing an operation for a capture control during each capture in the related art, a single operation (e.g., first trigger operation) for the capture control can generate consecutive capture operations for a virtual pet. In addition, a success probability of each capture exists independently (less than 1). This manner reduces user interactions from the operation source. Users do not need to perform a separate trigger action for each capture, and can start a consecutive capture procedure through a single operation. Accordingly, multiple trigger operations in the related art are simplified to a single trigger operation, which reduces operation burden and operation time consumption of users. Meanwhile, the continuity of consecutive capture avoids efficiency losses caused by intervals between single operations, so that more capture attempts can be completed within the same period of time. Finally, without changing the success probability of a single capture, this application does not require performing multiple operations on the capture control. By optimizing operation logic and simplifying the operations, the efficiency of capturing the virtual pet is improved.

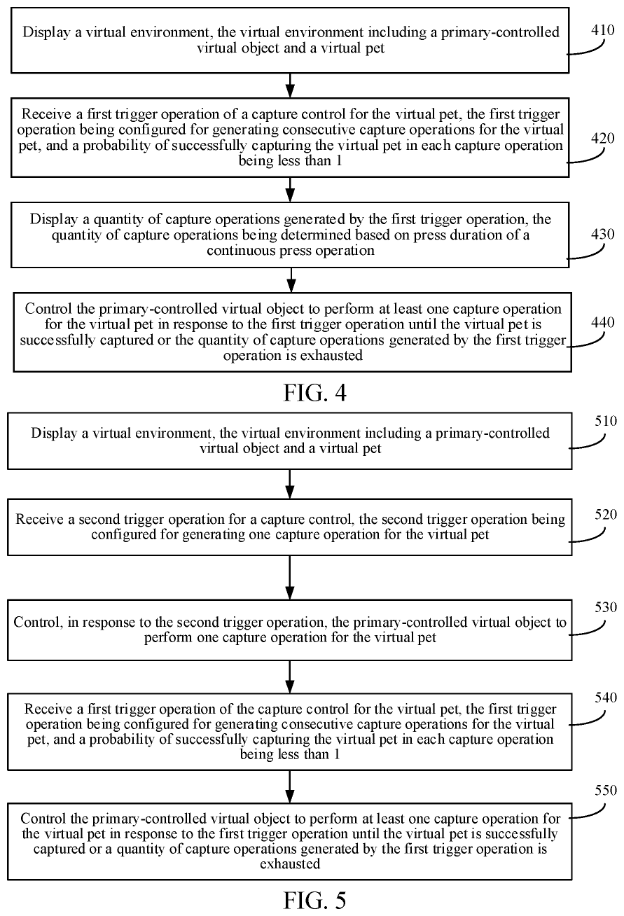

FIG. 4 shows a flowchart of a virtual object control method according to an embodiment of this application. Operations of the method may be performed by the terminal device 10 in the computer system shown in FIG. 1. For example, the operations may be performed by the client of the foregoing target application. In the following method embodiments, for ease of description, the operations are performed only by the “client”. The method may include at least one of the following operations (410 to 440).

Operation 410: Display a virtual environment, the virtual environment including a virtual object and a virtual pet. In some embodiments, the computer device displays a graphical user interface of the virtual environment on a screen as depicted in the figures described below and the virtual environment includes a virtual object and a virtual pet. The virtual object is controlled by a user of the computer device as a virtual character in the virtual environment.

Operation 420: Receive a first trigger operation on a capture control for the virtual pet, the first trigger operation being configured for generating consecutive capture operations for the virtual pet, and a probability of successfully capturing the virtual pet in each capture operation being less than 1.

Operation 430: Display the quantity of capture operations generated by the first trigger operation, the quantity of capture operations being determined based on a press duration of the continuous press operation.

In some embodiments, the first trigger operation is a continuous press operation. The quantity of capture operations is determined based on the press duration of the continuous press operation. A correspondence table between the press duration and the quantity of capture operations is preset. After the press duration is determined, the quantity of capture operations corresponding to the press duration is determined from the correspondence table. A functional relationship between the press duration and the quantity of capture operations is preset. After the press duration is determined, the quantity of capture operations corresponding to the press duration is determined based on the functional relationship.

In some embodiments, the quantity of capture operations is continuously increased during execution of the first trigger operation.

One capture operation is added each time the press duration reaches a first duration during execution of the first trigger operation. By way of example, the first duration is 3 seconds. During execution of the first trigger operation, the quantity of capture operations is determined as 1 when the press duration reaches 3 seconds. When the press duration reaches 6 seconds, one capture operation is added to determine the quantity of capture operations as 2. When the press duration reaches 9 seconds, one capture operation is added again to determine the quantity of capture operations as 3.

By way of example, the press duration required for addition of one capture operation may change as the quantity of capture operations is increased. In the first manner, the press duration required for addition of one capture operation increases along with the increase of the quantity of capture operations. By way of example, one capture operation is added every 3 seconds at the initial stage, and when the quantity reaches 3, one capture operation is added every 6 seconds. For example, during execution of the first trigger operation, the quantity of capture operations is determined as 3 when the press duration reaches 9 seconds. The quantity of capture operations is determined as 4 (i.e., one more capture operation is added within a 6-second period after the 9^{th} second) when the press duration reaches 15 seconds. In the second manner, the press duration required for addition of one capture operation decreases along with the increase of the quantity of capture operations. By way of example, one capture operation is added every 3 seconds at the initial stage, and when the quantity reaches 3, one capture operation is added every 1 seconds. For example, during execution of the first trigger operation, the quantity of capture operations is determined as 3 when the press duration reaches 9 seconds. The quantity of capture operations is determined as 9 (i.e., one more capture operation is added within a 6-second period after the 9^{th} second, and 6 capture operations are added) when the press duration reaches 15 seconds. Such manner of increasing the quantity of capture operations at unequal intervals diversifies the manner of determining the quantity of capture operations. The first manner raises the difficulty of increasing the quantity of capture operations, while the second manner can quickly increase the quantity of capture operations, which enriches human-computer interaction forms.

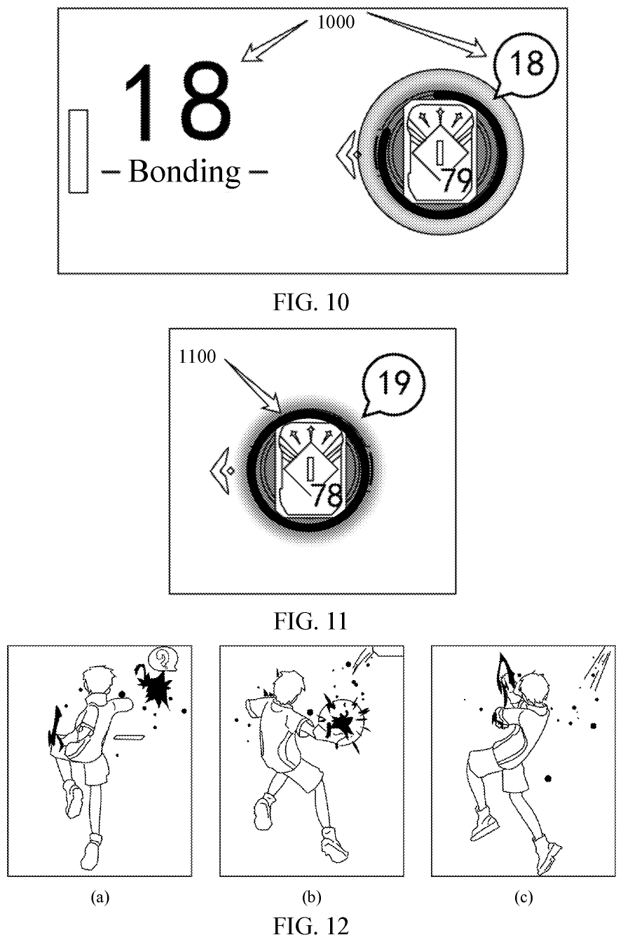

In practical application, along with execution of the first trigger operation, the increasing quantity of capture operations as the press duration increases is displayed on the UI. In some embodiments, the quantity of capture operations is displayed in a digital form. In some embodiments, the quantity of capture operations is indicated by a progress bar. As shown in FIG. 9, the increasing quantity of capture operations as the press duration increases is displayed on the UI. For example, the quantity of capture operations 910 changes to the quantity of capture operations 920, i.e., from 8 to 18. As shown in FIG. 10, the quantity of capture operations 1000 (i.e., number 18) indicates that the quantity of capture operations corresponding to the current press duration is 18.

The technical solutions provided in the embodiments of this application display the quantity of capture operations to enable users to clearly perceive the quantity of capture operations. This not only enriches the display forms of images, but also enriches human-computer interaction forms. Furthermore, the real-time display of the quantity and progress of capture operations allows users to make targeted decisions based on the information, so as to avoid misoperations or interrupted experience caused by information asymmetry. Meanwhile, the quantity display enhances feedback and controllability. Although consecutive capture is triggered by a single operation, the real-time updated quantity provides sustained interactive feedback for users. Users can perceive that the terminal device is executing the capture procedure as expected rather than staying unresponsive. This feedback mechanism boosts users' trust in operations and eliminates operation doubts arising from opaque procedures. Based on simplified operations and improved efficiency, the completeness and satisfaction of user experience are further enhanced.

The foregoing embodiments illustrate the manner of determining the quantity of capture operations based on the press duration of the continuous press operation. Other manners of determining the quantity of capture operations are described below.

In some embodiments, the quantity of capture operations is determined based on an operation position of the first trigger operation.

In practical application, different positions where the first trigger operation is performed for the capture control correspond to different quantities of capture operations. By way of example, a response area of the capture control is divided into a plurality of sub-areas, and different sub-areas correspond to different quantities of capture operations. By way of example, prompt information indicating the quantity of capture operations corresponding to different sub-areas is displayed after the capture control is pressed. For example, prompt information is displayed in response to a press operation on the capture control, and the quantity of capture operations is determined in response to a drag operation. The drag operation starts from the press operation. Based on an end position of the drag operation, a sub-area corresponding to the end position is determined, and the quantity of capture operations corresponding to the sub-area is determined. The prompt information prompts boundary positions of different sub-areas and the quantity of capture operations corresponding to each sub-area.

In some embodiments, the quantity of capture operations is determined based on an operation pressure of the first trigger operation. By way of example, the first trigger operation is a press operation.

In practical application, the operation pressure of the first trigger operation is obtained by a pressure sensor of the terminal device. The operation pressure is positively correlated with the quantity of capture operations. To be specific, a higher operation pressure of the first trigger operation indicates a larger quantity of capture operations corresponding to the first trigger operation. A lower operation pressure of the first trigger operation indicates a smaller quantity of capture operations corresponding to the first trigger operation. After the operation pressure of the first trigger operation is obtained by the pressure sensor of the terminal device, the quantity of capture operations corresponding to the operation pressure is determined based on a relationship between the operation pressure and the quantity of capture operations.

Apart from the press duration, the technical solutions provided in the embodiments of this application can flexibly determine the quantity of capture operations by means of the operation position, the operation pressure, and other factors. Compared with the continuous press operation, the manner of flexibly determining the quantity of capture operations by means of the operation position, the operation pressure, and other factors are simpler and more time-efficient, so that this application enriches the manners of determining the quantity of capture operations and reduces processing costs. Since the operation position and the operation pressure belong to transient operation features, binding the operation features with the quantity of capture operations allows users to complete the quantity setting instantly via one precise position selection or pressure control, without any waiting process, thereby shortening operation time and reducing an error probability caused by prolonged actions. In addition, such operation manners conform better to users' natural interaction habits. For example, clicking/tapping a left sub-area of a screen by a user corresponds to 5 capture operations while clicking/tapping a right sub-area corresponds to 10 capture operations. Alternatively, a light press corresponds to 3 capture operations, and a heavy press corresponds to 8 capture operations. The operation logic fits human action instincts and reduces learning costs. Furthermore, different operation manners can adapt to diverse scene requirements (e.g., pressure control is adopted to improve efficiency for rapid consecutive capture, and position selection is adopted to enhance accuracy for precise quantity setting). While enriching interaction forms, the manner of transient operations and instant feedback further reduces the pressure of the terminal device in identifying and processing sustained actions by the terminal device, thereby relieving users' operation burden, indirectly optimizing resource consumption of the terminal device, and achieving improvements in both user experience and technical costs.

Operation 440: Control the virtual object to perform at least one capture operation on the virtual pet in response to the first trigger operation until the virtual pet is successfully captured or a quantity of capture operations generated by the first trigger operation is exhausted.

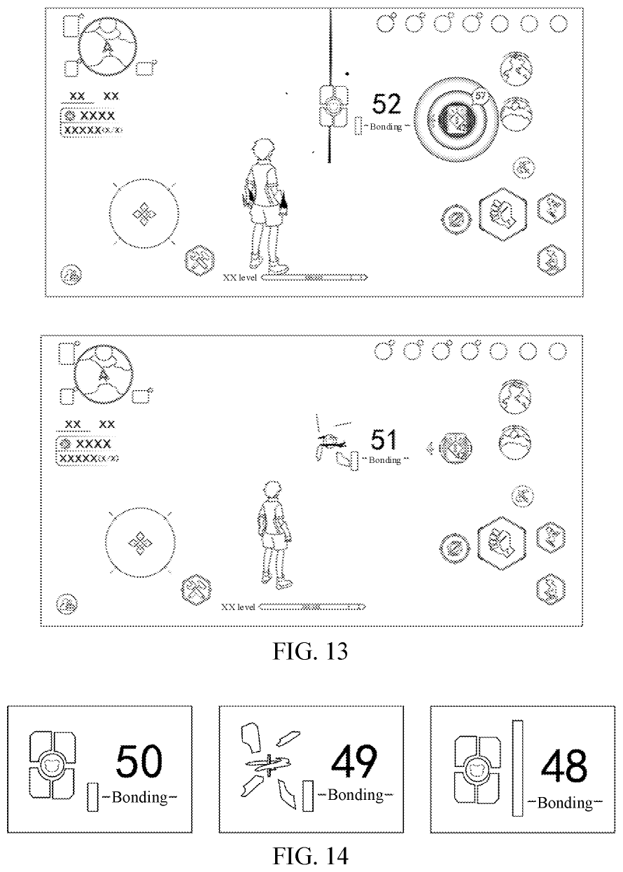

In some embodiments, one is subtracted from the quantity of capture operations upon each execution of a capture operation. As shown in FIG. 13, after the first trigger operation ends, at least one capture operation is initiated and a capture result is determined. The remaining quantity of capture operations is reduced from 52 to 51.

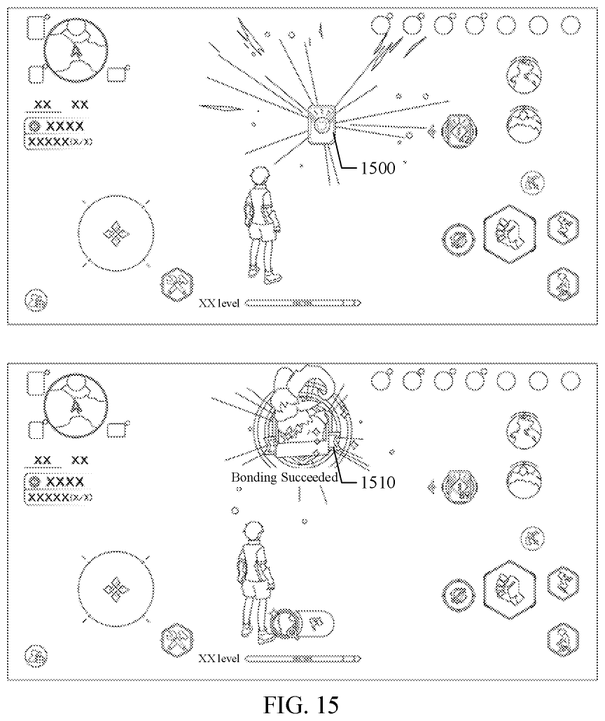

In practical application, when the virtual object is controlled to perform at least one capture operation on the virtual pet, one is subtracted from the quantity of capture operations upon each execution of a capture operation. When the virtual object is controlled to perform at least one capture operation on the virtual pet, the decreasing quantity of capture operations may be displayed. As shown in FIG. 14, one is subtracted from the quantity of capture operations upon each execution of a capture operation. For example, the quantity of capture operations is reduced from 50 to 49 and then to 48.

By way of example, the quantity of capture operations generated by the first trigger operation is K. Upon execution of a capture operation, the quantity of capture operations is displayed as K-1. Upon execution of two capture operations, the quantity of capture operations is displayed as K-2. When the virtual object is controlled to perform at least one capture operation on the virtual pet, the updated quantity of capture operations refers to the remaining quantity of capture operations.

The technical solutions provided in the embodiments of this application realize dynamic changes of the quantity of capture operations by continuously increasing the quantity of capture operations during execution of the first trigger operation and subtracting one from the quantity of capture operations upon each execution of a capture operation. Similarly, the dynamically changed quantity of capture operations is displayed to facilitate continuous execution of the continuous press operation or stop of the continuous press operation. Users can also learn the quantity of capture operations already performed by controlling the virtual object and the remaining quantity of capture operations, so as to facilitate the users to make targeted decisions (e.g., keeping waiting when the remaining quantity is sufficient and preparing supplementary operations in advance when the quantity is insufficient), thereby avoiding misoperations or experience interruption caused by information asymmetry.

The following describes the quantity of capture props consumed in each capture operation.

In some embodiments, capture operations among the at least one capture operation consume the same quantity of capture props.

In practical application, the capture props are configured to capture the virtual pet. The capture prop is a virtual prop obtained by the virtual object from the virtual environment, or a virtual prop obtained by exchanging virtual resources from the virtual environment.

By way of example, each capture operation needs to consume capture props, and the capture operations consume the same quantity of capture props. By way of example, each capture operation consumes a first value of capture props. The first value is a preset value and may be set based on actual demands. For example, the first value is set to 1.

When there are no capture props left, the virtual object cannot be controlled to perform capture operations even if there are still remaining quantities of capture operations. To be specific, a capture operation can only be executed when capture props are consumed.

By way of example, if the virtual object has 10 capture props and each capture operation consumes 1 capture prop, a maximum quantity of executable capture operations is 10. To be specific, the quantity of capture operations generated by the first trigger operation is 10.

In some embodiments, a quantity of capture props consumed in an i^{th} capture operation among the at least one capture operation is positively correlated with a value of i, i being a positive integer.

By way of example, a larger value of i indicates a larger quantity of capture props consumed in the i^{th} capture operation. For example, the i^{th} capture operation consumes i capture props. To be specific, the first capture operation consumes one capture prop, the second capture operation consumes two capture props, the third capture operation consumes three capture props, and so on.

By way of example, a larger value of i indicates an unchanged or larger quantity of capture props consumed in the i^{th} capture operation. For example, an operation quantity interval of i is determined, the first to third capture operations are performed based on the operation quantity interval, and each capture operation consumes one capture prop. The fourth to sixth capture operations are performed, and each capture operation consumes two capture props. The seventh to ninth capture operations are performed, and each capture operation consumes three capture props, and so on.

In some embodiments, a quantity of capture props consumed in each capture operation among the at least one capture operation is positively correlated with the rarity of the virtual pet.

In practical application, the virtual pets may be divided into different rarity levels (four levels including common, rare, epic, and legendary). Corresponding single capture prop consumption standards are set for different levels, and the consumption quantity increases positively along with the rise of rarity. Meanwhile, combined with a consecutive capture scene, the single consumption standard is applied to each capture operation synchronously, ensuring that a target with higher rarity brings higher total prop consumption for both single capture and consecutive capture. For example, if a common virtual pet corresponds to one capture prop consumed per capture operation, 10 consecutive capture operations need to consume 10 capture props. For a rare virtual pet with higher rarity, two capture props are consumed per capture operation, and 10 consecutive capture operations need to consume 20 basic props. For an epic virtual pet, three capture props are consumed per capture operation, and the total consumption for consecutive capture rises synchronously. As the target of the highest rarity, a legendary virtual pet requires five capture props per capture operation. The gradient difference in prop consumption directly reflects the difference in capture costs for pets of different rarities. This not only conforms to user cognition that high-value targets require high investment, but also highlights the scarcity and obtaining sense of achievement of rare pets through differentiated costs.

According to the technical solutions provided in the embodiments of this application, the quantity of capture props consumed in each capture operation may be the same or different. When a larger quantity of capture operations indicates a larger quantity of capture props consumed in the current capture operation, it means that additional conditions exist for performing more consecutive capture operations, thereby providing users with richer capture experience and realizing more diversified capture forms. In addition, the embodiments of this application support differentiated consumption quantities of capture props (e.g., increasing consumption along with the increase of the quantity of capture operations or dynamically changing consumption based on the rarity of virtual pets). This provides users with multi-layered decision-making space. For example, users can select a steady mode with small quantity and low consumption or an efficient mode with large quantity and high consumption based on corresponding prop reserves, thus upgrading capture behaviors from a single operation to strategic resource allocation. Meanwhile, the differentiated prop consumption manners can match the demands of diverse game scenes. For a common virtual pet, fixed prop consumption may be adopted to reduce an operation threshold. For a rare virtual pet, the challenge of capture can be increased by consuming more capture props for a larger quantity of capture operations, making the obtaining of the rare virtual pet more valuable, and avoiding monotonous gameplay caused by undifferentiated prop consumption. Furthermore, this manner can also guide users to manage game resources more rationally and reduce waste or excessive consumption of props. While enriching capture forms, a linkage mechanism of “operation-resource-result” enhances the depth and fun of gameplay, enabling users to obtain layered experience during the capture process instead of performing simple repetitive operations.

The following describes timing for the virtual object to throw capture props.

In some embodiments, the virtual object is controlled to throw the capture prop toward the virtual pet once if the quantity of capture operations is increased during execution of the first trigger operation.

By way of example, during execution of the first trigger operation, if the quantity of capture operations increases from, for example, 1 to 2, the virtual object is controlled to throw the capture prop toward the virtual pet once. The quantity of the thrown capture props is the same as the quantity of capture props consumed in the second capture operation. By way of example, each capture operation consumes one capture prop. If the quantity of capture operations increases by one, the virtual object is controlled to throw one capture prop toward the virtual pet.

By way of example, the terminal device may also display a throwing animation when the virtual object is controlled to throw one capture prop toward the virtual pet.

In some embodiments, the virtual object is controlled to throw the capture prop toward the virtual pet once prior to performing each capture operation among the at least one capture operation.

By way of example, during execution of the first trigger operation, the virtual object is not controlled to throw capture props toward the virtual pet. After the first trigger operation ends, when the virtual object is controlled to perform capture operations, the virtual object is controlled to throw capture props toward the virtual pet. By way of example, prior to performing an i^{th} capture operation among the at least one capture operation, the virtual object is controlled to throw capture props consumed in the i^{th} capture operation toward the virtual pet.

According to the technical solutions provided in the embodiments of this application, the virtual object is controlled to throw capture props toward the virtual pet during execution of the first trigger operation. This prevents the execution process of the first trigger operation from being monotonous. Combined with the throwing animation displayed on the UI, display elements of images are enriched. In addition, prior to performing each capture operation among the at least one capture operation, the virtual object is controlled to throw capture props. Combining the throwing animation with each capture operation can bring users a more vivid capture experience.

In some embodiments, the virtual object presents a different posture on each throw of the capture prop.

By way of example, the virtual object presents different postures when throwing capture props in different throwing processes for capture props. By way of example, users can learn the current quantity of capture operations through the displayed throwing postures of the virtual object. The postures presented by the virtual object on each throw of the capture prop include at least one of the following: throwing capture props sideways with one hand, throwing capture props with both hands raised above the head, and kicking capture props.

By way of example, the virtual object throwing capture props with different postures is displayed. Each posture corresponds to a different quantity of capture operations or a different quantity of completed capture operations. As shown in sub-figure a, sub-figure b, and sub-figure c of FIG. 12, the virtual object throws capture props with different postures.

With different postures for throwing capture props, for example, adopting a relaxed one-handed throwing posture for the first throw and switching to a forceful two-handed throwing posture for the fifth throw, the technical solutions provided in the embodiments of this application enrich the display elements of the images. The detail differences between different postures (e.g., the swing range of arms and the change of body center of gravity) create richer image dynamics. This turns the consecutive capture process from mechanical repetition into rhythmic visual presentation and enhances users' immersive experience. In addition, different postures indicate different quantities of capture operations and improve the efficiency of information display, providing users with more diverse capture experience. Binding posture differences with the quantity of capture operations (e.g., a specific posture corresponds to a fixed quantity interval), allows users to directly determine the current capture progress through vision without checking the value of the quantity additionally. For example, when viewing that the virtual object performs a large-amplitude throwing posture, users can quickly recognize that it has entered the stage of a large quantity of capture operations. This manner of delivering information via postures integrates visual perception and information obtaining, reduces users' cost of information retrieval, and improves the efficiency of operation decision-making. Furthermore, differentiated postures can also connect emotions and strategies to the capture process. For example, capturing a rare virtual pet can be matched with special ceremonial throwing postures. This visually highlights the particularity of rare targets and brings users a stronger sense of participation and anticipation during operation. While enriching image elements and improving information efficiency, visual narration further enhances the fun and memorable features of the capture gameplay.

The following describes the obtaining and return of capture props.

In some embodiments, when the virtual pet is successfully captured and the quantity of capture operations generated by the first trigger operation is not exhausted, the capture props corresponding to the unexhausted quantity of capture operations are returned to an inventory of the virtual object, the capture props thrown by the virtual object being obtained from the inventory of the virtual object.

By way of example, the quantity of capture operations generated by the first trigger operation corresponds to a plurality of capture props. Specifically, for the manner of determining the total quantity of consumed capture props corresponding to the quantity of capture operations, refer to the description of the following embodiments. Details are not described again herein.

By way of example, if the quantity of capture operations generated by the first trigger operation is K, the quantity of capture props to be consumed is L, where L is an integer greater than or equal to K.

If the virtual pet is successfully captured in an n^{th} capture operation and n is an integer less than K, the quantity of capture operations generated by the first trigger operation is unexhausted. A total of M capture props are consumed in the previous n capture operations, where M is less than L. The capture props corresponding to the remaining (K-n) capture operations are returned to the inventory of the virtual object. The unconsumed (L-M) capture props are returned to the inventory of the virtual object.

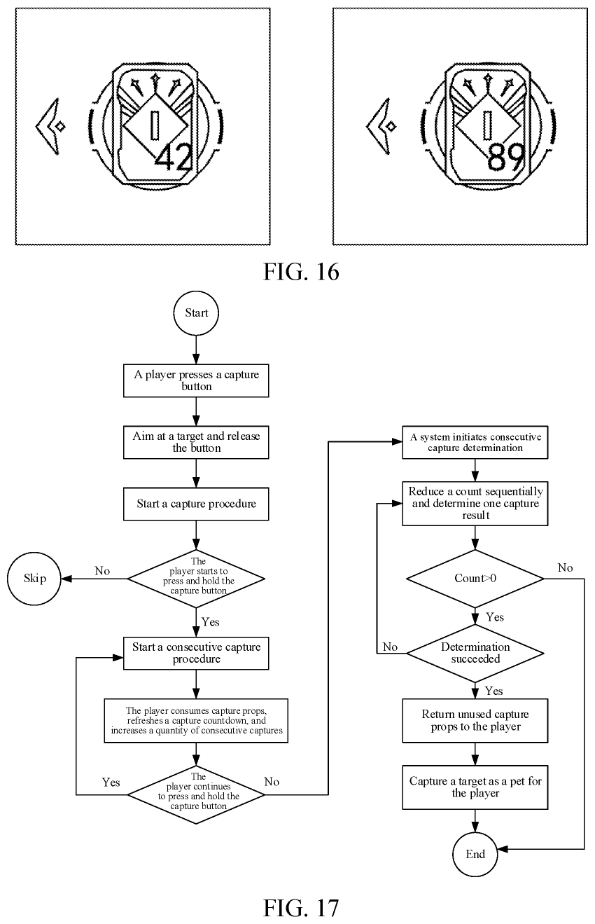

By way of example, if the quantity of capture operations generated by the first trigger operation is K, the L capture props to be consumed are obtained from the inventory of the virtual object, and will be returned to the inventory of the virtual object during the return process. As shown in FIG. 16, the capture props corresponding to the unexhausted quantity of capture operations are returned to the inventory of the virtual object, and the quantity of capture props changes from 42 to 89.

According to the technical solutions provided in the embodiments of this application, the capture props corresponding to the unexhausted quantity of capture operations are returned to the inventory of the virtual object, thereby avoiding waste of capture props and realizing flexible application of capture props. Furthermore, in a consecutive capture scene, if the props corresponding to the unexhausted quantity of capture operations are directly consumed without being returned, users may be forced to reduce capture quantity selection out of concern for prop waste, or have negative experience due to the inability to recycle remaining props after successful capture. This limits the flexibility of operation strategies. The prop return mechanism completely eliminates such concerns. Users can safely select a large quantity of consecutive capture operations (e.g., 10 preset capture operations), without worrying that the props for the remaining 9 operations will be wasted after an early successful capture. Thus users can adjust strategies more freely based on the rarity of virtual pets and capture difficulty (e.g., directly enabling a maximum quantity of capture operations for high-difficulty targets without reserving props). Meanwhile, this manner strengthens the controllability of prop resources. The returned props may be reused in other capture scenes to avoid idle resources in a single capture process and improve the overall utilization rate of props. Especially when obtaining props involves costs (e.g., unlocking via tasks or exchanging with game coins), this manner reduces users' pressure on resource obtaining and prolongs the service life of props. Furthermore, a closed-loop manner of operation-result-resource feedback formed by prop return enhances users' sense of trust. Users can perceive proper management of resources and eliminate doubts about involuntary consumption caused by opaque rules. While avoiding waste and improving flexibility, the sense of security over resources further increases users' acceptance and willingness to explore the capture gameplay.

The following describes the flexible selection of capture props.

In some embodiments, at least one virtual prop is displayed in response to the first trigger operation, each virtual prop adopting a different capture manner to capture the virtual pet.

By way of example, the first trigger operation is a press operation. In response to a press operation on the capture control, mark information respectively corresponding to at least one virtual prop is displayed, and different pieces of mark information correspond to different virtual props. The at least one virtual prop is a prop for capturing virtual pets. Different virtual props adopt different manners to capture virtual pets, such as binding, stunning, and trapping.

In some embodiments, in response to a selection operation for a first virtual prop among the at least one virtual prop, the first virtual prop is determined as the capture prop consumed in the capture operation, the selection operation being a swiping operation starting from a trigger position of the first trigger operation and ending at a position of the first virtual prop.

In some embodiments, in response to a selection operation for mark information corresponding to the first virtual prop among the at least one virtual prop, the first virtual prop is determined as the capture prop consumed in the capture operation.

By way of example, after the mark information corresponding to the first virtual prop is selected, the user may swipe back to the capture control while maintaining the previous continuous press state without interrupting the first trigger operation. The capture props to be consumed are selected during execution of the first trigger operation.

The technical solutions provided in the embodiments of this application allow users to select capture props consumed in the capture operation during execution of the first trigger operation, which reflects the flexibility and diversity of prop selection. Meanwhile, the first trigger operation will not be interrupted, extra operations are avoided, and the operation efficiency is improved. Furthermore, if prop selection needs to be completed before the first trigger operation, users need to interrupt the current consecutive capture process and re-enter a prop selection interface when encountering unexpected scenes (e.g., finding that the target is more sensitive to a specific prop during capture). This increases operations and may cause users to miss the capture opportunity due to interruption. Supporting dynamic selection of capture props during the first trigger operation enables users to flexibly switch prop types (e.g., rare props with higher success rates) based on real-time capture feedback (e.g., failed capture using ordinary props in previous attempts), without breaking the rhythm of consecutive capture, thereby realizing efficient interaction with uninterrupted operations and adjustable strategies as needed. Meanwhile, this manner makes prop selection more adaptable to scenes. Users do not need to predict the capture difficulty in advance, and can adjust prop combinations (e.g., alternating between ordinary props and special-effect props) in real time based on the performance of the target (e.g., struggling intensity of virtual pets and escape probability prompts) during consecutive capture, so as to prevent low capture efficiency caused by incorrect prop selection in advance. Furthermore, dynamic prop selection enhances users' sense of control over operations. Compared with passive consumption of fixed props, users can take charge of the capture process by actively switching props. Especially when multiple props have respective advantages (e.g., prop A is low in consumption and prop B is high in success rate), users can balance resource consumption and capture effect more accurately. While ensuring operation efficiency, the improved strategic freedom makes the capture process more personalized and controllable, and eliminates the experience limitations brought by the use of a single prop.

The following describes the consecutive capture procedure, including at least one of the following operations S1 to S3 (not shown in the figure).

Operation S1: Control, for an i^{th} capture operation among the at least one capture operation, the virtual object to perform the i^{th} capture operation on the virtual pet, i being a positive integer.

By way of example, starting from the first capture operation, it is determined whether the virtual pet is successfully captured in each capture operation. If the virtual pet is not successfully captured, the next capture operation is continued. If the virtual pet is successfully captured, the capture operation is stopped.

Operation S2: Perform, when the i^{th} capture operation fails to capture the virtual pet, an (i+1)^{th} capture operation among the at least one capture operation until the quantity of capture operations generated by the first trigger operation is exhausted.

By way of example, if the virtual pet is still not successfully captured in the last capture operation, it is determined that the virtual pet fails to be captured even if the quantity of capture operations generated by the first trigger operation is exhausted.

Operation S3: Skip performing subsequent capture operations if the i^{th} capture operation successfully captures the virtual pet, and control the virtual pet to become a pet owned by the virtual object.

By way of example, when the virtual pet is successfully captured in the i^{th} capture operation, an animation of successful capture is displayed. The animation of successful capture prompts that the virtual pet has been captured successfully. As shown in FIG. 15, when an i^{th} capture operation consumes a capture prop 1500 and a virtual pet is successfully captured, an animation 1510 of successful capture is displayed.

By way of example, after the virtual pet is set as a pet owned by the virtual object, the virtual object (or user account) may control the virtual pet, such as controlling the pet to move, release skills, and work. After the virtual pet becomes a pet owned by the virtual object, the virtual pet is always located around the virtual object.

The technical solutions provided in the embodiments of this application sequentially determine whether the virtual pet is successfully captured in each capture operation. If the virtual pet is successfully captured, subsequent capture operations will not be performed. If the virtual pet is not successfully captured, the next capture operation will be performed. This reflects the capture rule of consecutive capture operations, facilitates the implementation of consecutive captures, and avoids the waste of capture operations.

FIG. 5 shows a flowchart of a virtual object control method according to an embodiment of this application. Operations of the method may be performed by the terminal device 10 in the computer system shown in FIG. 1. For example, the operations may be performed by the client of the foregoing target application. In the following method embodiments, for ease of description, the operations are performed only by the “client”. The method may include at least one of the following operations (510 to 550).

Operation 510: Display a virtual environment, the virtual environment including a virtual object and a virtual pet. In some embodiments, the computer device displays a graphical user interface of the virtual environment on a screen as depicted in the figures described below and the virtual environment includes a virtual object and a virtual pet. The virtual object is controlled by a user of the computer device as a virtual character in the virtual environment.

The following describes in conjunction with operation 520 and operation 530 that one capture operation needs to be triggered before consecutive captures are triggered.

Operation 520: Receive a second trigger operation on the capture control, the second trigger operation being configured for generating one capture operation on the virtual pet.

In some embodiments, the second trigger operation is an operation for the capture control, such as a press operation or a click/tap operation.

Operation 530: Control, in response to the second trigger operation, the virtual object to perform one capture operation on the virtual pet.

In some embodiments, after the second trigger operation ends, the virtual object is controlled to perform one capture operation on the virtual pet. By way of example, this capture operation also consumes capture props. This capture operation is identical to one capture operation among the foregoing consecutive capture operations. The probability of successfully capturing the virtual pet via this capture operation is less than 1.

According to the technical solutions provided in the embodiments of this application, one capture operation is triggered prior to triggering consecutive capture operations, and this capture operation leads to the consecutive capture operations. This enriches the capture forms for virtual pets and reflects the diversity and flexibility of virtual pet capture. Moreover, a progressive manner from single triggering to continuous triggering provides users with a natural operation buffer. The first capture serves as a trial and perception process. Users can directly learn about the current capture difficulty of the virtual pet (e.g., a success probability and response to props), as well as a feedback effect of a single operation (e.g., throwing animations and failure prompts) through this operation, so as to determine whether to start subsequent consecutive captures and avoid risks caused by blindly enabling the continuous mode. Meanwhile, this manner conforms to users' operation cognition habits. The progression from single attempts to batch execution simulates the real-world decision logic of testing before investment, lowers the learning threshold of a consecutive capture function, and saves users from understanding complex rules for consecutive operations directly. Furthermore, the first capture realizes procedure connection. If the first capture succeeds, the procedure may be terminated directly to avoid resource redundancy caused by activating consecutive operations. If the first capture fails, users can adjust strategies based on failure feedback (e.g., prompts for using enhanced props) before starting consecutive captures. This turns capture behaviors from passive execution into targeted operations after active determination. While enriching capture forms, the smooth operation transition and controllable decisions further improve users' sense of security and operation experience fluency.

In some embodiments, operation 530 includes at least one of the following operations 531 to 534 (not shown in the figure).

Operation 531: Display, in response to a press operation on the capture control, a crosshair for the capture prop consumed in this capture operation.

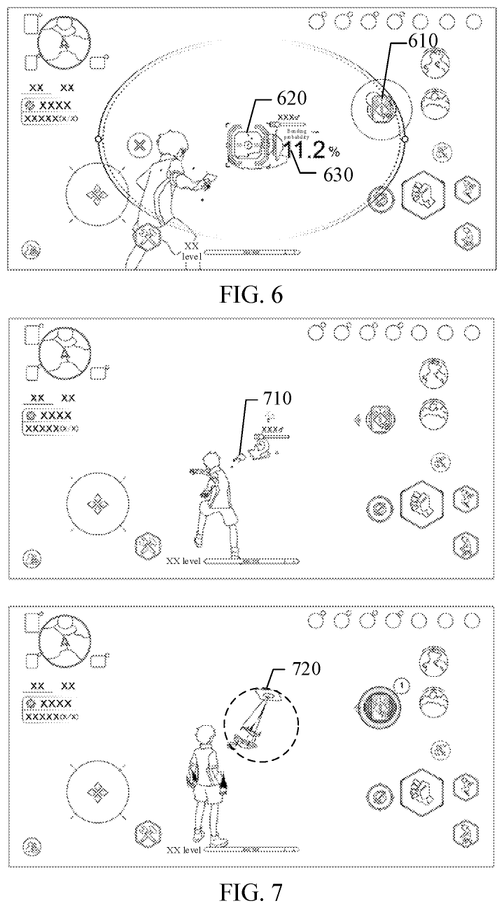

As shown in FIG. 6, in response to a press operation for a capture control 610, a crosshair 620 for the capture prop consumed in this capture operation is displayed.

The crosshair refers to an aiming crosshair for the capture prop, and indicates a position aimed when throwing the capture prop.

Operation 532: Control, in response to a drag operation for the capture control, a position of the crosshair to change, the drag operation starting from a press position of the press operation, and the position of the crosshair being associated with a real-time position of the drag operation.

By way of example, the drag operation for the capture control may change the aiming crosshair for the capture prop and change the aiming position of the capture prop.

Operation 533: Display, when the crosshair hits the virtual pet, a first capture probability for the virtual pet, the first capture probability being a probability of successfully capturing the virtual pet in this capture operation.

As shown in FIG. 6, when the crosshair hits the virtual pet, a first capture probability 630 for the virtual pet is displayed.

By way of example, when the crosshair hits different positions of the virtual pet, the capture probabilities for the virtual pet are different. For example, the capture probability when the crosshair hits an arm of the virtual pet is lower than the capture probability when the crosshair hits the head of the virtual pet.

By way of example, when the crosshair hits different virtual objects, the capture probabilities for these virtual objects are different. When the crosshair hits a non-capturable virtual object, the capture probability for the virtual object is 0. When the crosshair hits different capturable virtual pets, the capture probabilities for different virtual pets are different.

Operation 534: Control, in response to the end of the drag operation, the virtual object to throw the capture prop consumed in this capture operation toward the virtual pet, so as to capture the virtual pet at the first capture probability.

By way of example, when the finger performing the drag operation leaves the capture control, the drag operation is deemed completed. The virtual object is controlled to throw the capture prop consumed in one capture operation toward the position of the crosshair, so as to capture the virtual pet at the first capture probability.

As shown in FIG. 7, the virtual object is controlled to throw a capture prop 710 consumed in one capture operation toward the virtual pet, and an animation 720 showing that the capture prop captures the virtual pet is displayed.

By way of example, if the virtual pet is not successfully captured in this capture operation, subsequent consecutive capture operations are performed. If the virtual pet is successfully captured in this capture operation, subsequent consecutive capture operations will not be performed.

In the embodiments of this application, if the virtual pet is not successfully captured in this capture operation, the first capture probability remains unchanged during execution of at least one subsequent capture operation. The virtual pet is kept aimed throughout at least one subsequent capture operation, and no manual re-aiming is required, which helps increase the hit rate for the virtual pet.

The technical solutions provided in the embodiments of this application adopt one capture operation to initiate subsequent consecutive captures. Only one aiming action is needed in this capture operation, and no repeated aiming is required afterwards. To be specific, the subsequent consecutive captures directly adopt the aiming result, and capture operations are automatically performed without repeated manual calibration. This manner eliminates redundant operations caused by multiple aiming actions. Meanwhile, the one-time aiming that remains effective continuously ensures that subsequent captures always target the virtual pet accurately, reducing invalid captures resulting from aiming errors, simplifying operations, and improving capture efficiency. Meanwhile, the first capture probability remains unchanged in subsequent captures. Users do not need to worry about probability fluctuations after the initial capture, and can predict capture results based on an initial aiming state and a fixed probability, which further reduces decision interference. For example, after confirming accurate aiming and satisfactory probability through the initial capture, consecutive captures can be triggered with confidence. There is no need to adjust aiming or determine probability during the process, realizing dual guarantees of simplified operations and controllable results. Furthermore, the manner of initiating a consecutive procedure via a single trigger realizes a smoother capture process and avoids rhythm interruptions caused by multiple independent operations. Especially when the virtual pet is moving, one-time aiming locks the target for consecutive captures and prevents aiming failure due to target movement. While simplifying operations and improving efficiency, the dual stability of aiming and probability further boosts users' confidence and experience of successful capture.

The following describes duration indication information.

In some embodiments, after operation 530, duration indication information is displayed, the duration indication information indicating remaining duration for receiving the first trigger operation.

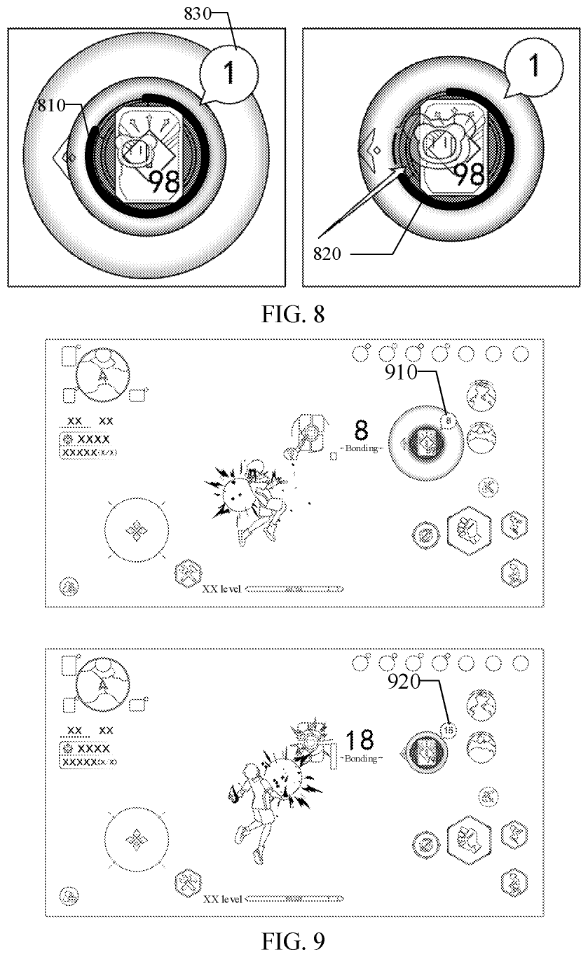

By way of example, the duration indication information starts to be displayed after the foregoing capture operation is performed. The duration indication information may be presented in the form of a progress bar countdown to show the remaining duration for receiving the first trigger operation. By way of example, the duration indication information indicates an initially preset duration, such as 10 seconds. As time elapses, the remaining duration indicated by the duration indication information decreases accordingly. As shown in FIG. 8, a progress bar 810 gradually shortens to a progress bar 820, and the indicated remaining duration keeps decreasing. As shown in FIG. 8, the quantity of capture operations is reduced from 830 to 1.

In some embodiments, only when the remaining duration indicated by the duration indication information is greater than the first value, operation 540 can be performed.

By way of example, only when the remaining duration indicated by the duration indication information is greater than the first value, operation 540 can be performed. By way of example, the first value is 0. Only when the remaining duration indicated by the progress bar is greater than 0, operation 540 can be performed. Conversely, when the remaining duration indicated by the progress bar is 0, operation 540 cannot be performed. To be specific, consecutive capture operations cannot be triggered.

According to the technical solutions provided in the embodiments of this application, consecutive capture operations cannot be triggered at will, and there are specific triggering timings. The first trigger operation can be received to trigger consecutive capture operations only when the remaining duration indicated by the duration indication information is greater than the first value. This application provides a trigger manner for consecutive capture operations, which enriches human-computer interaction forms and improves users' capture experience.

Operation 540: Receive a first trigger operation on a capture control for the virtual pet, the first trigger operation being configured for generating consecutive capture operations for the virtual pet, and a probability of successfully capturing the virtual pet in each capture operation being less than 1.

According to the technical solutions provided in the embodiments of this application, trigger timings are set through duration thresholds, so that consecutive captures can only be activated within a valid time window. For example, triggering is enabled only when the remaining duration of a capture window is sufficient to support at least two consecutive capture operations (greater than the first value). This prevents invalid consumption caused by activating consecutive captures with merely 1 second left within the window, which results in only one operation completed due to insufficient time, and ensures the validity of operations. Meanwhile, this triggering manner enhances the guidance of human-computer interaction. The binding of duration indication information and trigger permissions intuitively indicates whether the current scene is suitable for consecutive captures, and reduces misoperations caused by information asymmetry. There is no need to determine window duration manually. Proper trigger timings are screened out in advance by rules, which reduces the cost of operation decision-making. Furthermore, this manner makes the capture procedure more rhythmic. Users need to determine the activation timing according to duration prompts instead of triggering at will. The interactive logic of observation-determination-triggering turns disordered operations into strategic timing selection for consecutive captures, thereby not only enriching interaction forms, but also providing greater logic and controllability to the capture experience by improving scene adaptability. Operation chaos caused by arbitrary triggering is avoided, and the overall interaction fluency is further optimized.

The following describes refresh of duration indication information.

In some embodiments, in response to the first trigger operation, the duration indication information is updated with a preset duration if the quantity of capture operations is increased, the preset duration being a maximum value of the remaining duration.

By way of example, during execution of the first trigger operation, the duration indication information is updated with a preset duration if the quantity of capture operations is increased, the preset duration being a maximum value of the remaining duration. By way of example, if the real-time displayed quantity of capture operations corresponding to the first trigger operation changes from 2 to 3, the duration indication information is refreshed with the preset duration simultaneously when the quantity becomes 3. If the real-time displayed quantity of capture operations corresponding to the first trigger operation changes from 2 to 3, the remaining duration indicated by the duration indication information is refreshed to a maximum remaining duration of 10 seconds. As shown in FIG. 10 and FIG. 11, when the quantity of capture operations changes from 18 to 19, the remaining duration indicated by duration indication information (progress bar 1100) is refreshed.

By way of example, a third trigger operation is allowed to be received when the remaining duration indicated by the updated duration indication information is greater than the first value, and the third trigger operation is another trigger operation, different from the first trigger operation, for generating consecutive capture operations for the virtual pet.

According to the technical solutions provided in the embodiments of this application, the duration indication information is synchronously refreshed with a preset maximum duration. While users adjust the quantity, sufficient time buffer is provided for newly added operations. For example, when the quantity increases from 2 to 3, the remaining duration is immediately reset to a maximum value, ensuring that all three capture operations can be completed within a valid time window and preventing procedure interruption due to insufficient duration. Meanwhile, this refresh manner strengthens the real-time correlation between operations and feedback. The user action of adjusting the quantity and the visual feedback of duration reset take place synchronously. The increase of the quantity accompanied by duration guarantee can be perceived directly, and no extra confirmation on duration sufficiency is required, thus reducing hesitation in decision-making. Especially during consecutive capture, users can flexibly increase the quantity based on real-time capture effects (e.g., failures in the first two captures). The duration refresh mechanism eliminates the concern of insufficient duration after increasing the quantity, and enables more decisive strategy adjustment.

The following describes the timing for triggering consecutive captures.

In some embodiments, in response to completion of the first trigger operation, the operation of controlling the virtual object to perform at least one capture operation on the virtual pet is performed when the remaining duration indicated by the duration indication information is less than or equal to the first value.

By way of example, after the first trigger operation ends, if the remaining duration indicated by the duration indication information is greater than the first value, waiting continues until the remaining duration indicated by the duration indication information is less than or equal to the first value, and then operation 550 is triggered for execution. During the waiting process, the first trigger operation has ended, and the quantity of capture operations generated by the first trigger operation is displayed. It is clear that the third trigger operation for the capture control may also be received during the waiting process. The third trigger operation is similar to the first trigger operation. Details are not described again herein.

By way of example, the quantity of capture operations generated by the third trigger operation is determined based on the third trigger operation. After the third trigger operation ends, subsequent consecutive capture operations are triggered only if the remaining duration indicated by the duration indication information is less than or equal to the first value. At this time, the quantity of subsequent consecutive capture operations is the sum of the quantity of the capture operations generated by the first trigger operation and the quantity of the capture operations generated by the third trigger operation.

By way of example, after the third trigger operation ends, if the remaining duration indicated by the duration indication information is greater than the first value, waiting continues until the remaining duration indicated by the duration indication information is less than or equal to the first value. It is clear that a fourth trigger operation, a fifth trigger operation, and the like may be performed again during the waiting process. The fourth trigger operation and the fifth trigger operation are similar to the third trigger operation. Details are not described again herein.

According to the technical solutions provided in the embodiments of this application, consecutive captures are not started immediately after the first trigger operation ends. Consecutive captures are started only when the remaining duration indicated by the duration indication information is less than or equal to the first value. This manner provides users with a certain reaction time. When the quantity of capture operations is insufficient, trigger operations for the capture control can be performed again to increase the quantity of capture operations. It is clear that in case of accidental release causing interruption during execution of the first trigger operation and failure to increase the quantity of capture operations, the second trigger operation may be performed again to continue increasing the quantity of capture operations. This reflects the flexibility in determining the quantity of capture operations. Further, the manner of refreshing the duration indication information ensures that there is buffer time to perform trigger operations again no matter when the current trigger operation is interrupted subsequently, so as to provide a better capture experience for users.

Operation 550: Control the virtual object to perform at least one capture operation on the virtual pet in response to the first trigger operation until the virtual pet is successfully captured or a quantity of capture operations generated by the first trigger operation is exhausted.

The following describes the timing for transmitting requests to a server.

In some embodiments, an obtaining request is transmitted in response to the end of the first trigger operation, the obtaining request including operation information of the first trigger operation, and the obtaining request being configured for requesting to obtain the quantity of capture operations generated by the first trigger operation.

By way of example, the terminal device transmits an obtaining request to the server in response to the end of the first trigger operation, the obtaining request including operation information of the first trigger operation, and the obtaining request being configured for requesting to obtain the quantity of capture operations generated by the first trigger operation.

By way of example, the operation information of the first trigger operation includes at least one of the following: press duration, an operation position, and an operation pressure of the first trigger operation. The server receives the obtaining request, and determines the quantity of capture operations generated by the first trigger operation based on at least one of the carried press duration, operation position, and operation pressure. The server transmits the quantity to the terminal device.

Compared with the related art where information interaction is performed between the terminal device and the server for each capture operation, the technical solutions provided in the embodiments of this application only require one round of interaction after the first trigger operation ends to determine the quantity of capture operations generated by the first trigger operation. This reduces the quantity of interactions and reduces the server load.

In some embodiments, after at least one capture operation is performed until the virtual pet is successfully captured or the quantity of capture operations generated by the first trigger operation is exhausted, the terminal device transmits one piece of capture information to the server. The capture information indicates whether the virtual pet is captured successfully, as well as a state of the virtual pet and the quantity of capture operations.

By way of example, in the related art, the terminal device needs to transmit capture information to the server after each capture operation. This application combines multiple transmissions into one transmission through consecutive captures, which also reduces the server load.

In some embodiments, FIG. 17 shows a schematic diagram of a virtual pet capture procedure according to an embodiment of this application. The procedure includes at least one of the following operations P1 to P10 (not shown in the figure).

Operation P1: A player presses a capture button (i.e., capture control).

A client switches a player camera to an aiming mode. A crosshair appears at the center of a screen at this time. The player can drag the capture button to move and adjust the crosshair and a camera focus.

Operation P2: The player moves the crosshair onto a capturable target.

The client emits a ray from the crosshair to determine a type of a target currently aligned by the crosshair, such as terrain, unit, and building.

Operation P3: Pre-display a capture probability at a target position.

If the crosshair is aligned with the capturable target, the client reads configuration of a capture success probability of the target and displays the capture success probability of the target on a UI at the target position. The player can directly view the probability information and freely decide whether to proceed with subsequent capture operations.

Operation P4: The player releases the button to start a capture operation.

The client first initiates a protocol, and then a server returns a capture result to the client.

Operation P5: Whether the player presses and holds the capture button again?

True: Yes, enter a consecutive capture procedure. False: No, enter a single capture procedure.

Operation P6: The player consumes capture props, refreshes a capture countdown, and increases a count of consecutive captures.

The client reads time for which the player presses and holds the capture button and reports data to the server. The server deducts capture props accumulatively, increases a count of consecutive captures, and issues the data to the client.

Operation P7: Whether the player continues to press and hold the capture button?

True: Yes, return to perform operation P6. False: No, a system (i.e., a terminal device or the server) starts to determine a result of consecutive captures.

Operation P8: The system reduces the count sequentially and determines one capture result.

During determination, the system reduces the count sequentially and determines one capture result. The count herein refers to the remaining quantity of capture operations.

Operation P9: Reduce, if it is determined that the capture fails, the count and proceed to the next determination. Upon determination succeeded, counting is stopped, and the consecutive capture procedure ends. If the count is reduced to 0, the determination is stopped, and the consecutive capture procedure also ends.

Operation P10: Upon determination succeeded, the system returns unused capture props to the player, and captures the target as a pet for the player.

The target herein refers to the aforementioned virtual pet.

The technical solutions provided in the embodiments of this application allow players to perform consecutive pet capture operations by continuously pressing a button or a mouse, and bring various beneficial effects. Firstly, the solutions improve operation convenience and simplify repetitive and complicated action procedures. Secondly, this innovative manner enriches gaming experience, and increases the fun and appeal of the game through different action performances and feedback mechanisms. Meanwhile, consecutive capture operations improve capture efficiency, enabling players to reach game goals faster, optimizing resource utilization and reducing server load. Furthermore, more design space is provided for game developers, facilitating social interaction, so as to increase user stickiness and enhance brand image. In general, this application not only improves gaming experience for players, but also brings new opportunities and challenges to the development of the game industry.

The following are apparatus embodiments of this application, which may be configured to perform the method embodiments of this application. For details not disclosed in the apparatus embodiments of this application, refer to the method embodiments of this application.

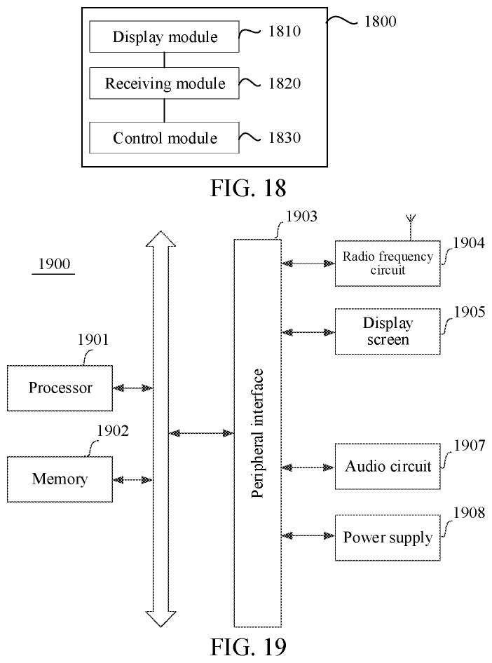

FIG. 18 is a block diagram of a virtual object control apparatus according to an embodiment of this application. The apparatus has functions for implementing the foregoing method for controlling a virtual object. The functions may be implemented by hardware, or may alternatively be implemented by hardware executing corresponding software. The apparatus may be the terminal device described above, or may be disposed in the terminal device. As shown in FIG. 18, an apparatus 1800 may include: a display module 1810, a receiving module 1820, and a control module 1830.

The display module 1810 is configured to display a virtual environment, the virtual environment including a virtual object and a virtual pet.

The receiving module 1820 is configured to receive a first trigger operation on a capture control for the virtual pet, the first trigger operation being configured for generating consecutive capture operations for the virtual pet, and a probability of successfully capturing the virtual pet in each capture operation being less than 1.

The control module 1830 is configured to control the virtual object to perform at least one capture operation on the virtual pet in response to the first trigger operation until the virtual pet is successfully captured or a quantity of capture operations generated by the first trigger operation is exhausted.

In some embodiments, the first trigger operation is a continuous press operation.

In some embodiments, the display module 1810 is configured to display the quantity of capture operations generated by the first trigger operation, the quantity of capture operations being determined based on a press duration of the continuous press operation.

In some embodiments, the control module 1830 is configured to continuously increase the quantity of capture operations during execution of the first trigger operation.

In some embodiments, the control module 1830 is configured to subtract one from the quantity of capture operations upon each execution of a capture operation.

In some embodiments, capture operations among the at least one capture operation consume the same quantity of capture props. Alternatively, a quantity of capture props consumed in an i^{th} capture operation among the at least one capture operation is positively correlated with a value of i, i being a positive integer. A quantity of capture props consumed in each capture operation among the at least one capture operation is positively correlated with the rarity of the virtual pet. The capture props are configured to capture the virtual pet.

In some embodiments, the control module 1830 is configured to control the virtual object to throw the capture prop toward the virtual pet once if the quantity of capture operations is increased during execution of the first trigger operation.

In some embodiments, the control module 1830 is configured to control the virtual object to throw the capture prop toward the virtual pet once prior to performing each capture operation among the at least one capture operation.

In some embodiments, the virtual object presents a different posture on each throw of the capture prop.

In some embodiments, the control module 1830 is configured to return, when the virtual pet is successfully captured and the quantity of capture operations generated by the first trigger operation is not exhausted, the capture props corresponding to the unexhausted quantity of capture operations to an inventory of the virtual object, the capture props thrown by the virtual object being obtained from the inventory of the virtual object.

In some embodiments, the display module 1810 is configured to display at least one virtual prop in response to the first trigger operation, each virtual prop adopting a different capture manner to capture the virtual pet.

In some embodiments, the control module 1830 is configured to determine, in response to a selection operation for a first virtual prop among the at least one virtual prop, the first virtual prop as the capture prop consumed in the capture operation, the selection operation being a swiping operation starting from a trigger position of the first trigger operation and ending at a position of the first virtual prop.

In some embodiments, the control module 1830 is configured to: control, for an i^{th} capture operation among the at least one capture operation, the virtual object to perform the i^{th} capture operation on the virtual pet, i being a positive integer; perform, when the i^{th} capture operation fails to capture the virtual pet, an (i+1)^{th} capture operation among the at least one capture operation until the quantity of capture operations generated by the first trigger operation is exhausted; and skip performing subsequent capture operations if the i^{th} capture operation successfully captures the virtual pet, and control the virtual pet to become a pet owned by the virtual object.

In some embodiments, the receiving module 1820 is configured to receive a second trigger operation on the capture control, the second trigger operation being configured for generating one capture operation on the virtual pet.

In some embodiments, the control module 1830 is configured to: control, in response to the second trigger operation, the virtual object to perform one capture operation on the virtual pet; and perform, after the start of one capture operation, the operation of receiving a first trigger operation on a capture control for the virtual pet.

In some embodiments, the display module 1810 is configured to display duration indication information, the duration indication information indicating remaining duration for receiving the first trigger operation.

In some embodiments, the receiving module 1820 is configured to receive the first trigger operation when the remaining duration indicated by the duration indication information is greater than a first value.

In some embodiments, the control module 1830 is configured to update, in response to the first trigger operation, the duration indication information with a preset duration if the quantity of capture operations is increased, the preset duration being a maximum value of the remaining duration. A third trigger operation is allowed to be received when the remaining duration indicated by the updated duration indication information is greater than the first value, and the third trigger operation is another trigger operation, different from the first trigger operation, for generating consecutive capture operations for the virtual pet.

In some embodiments, the control module 1830 is configured to perform, in response to completion of the first trigger operation, the operation of controlling the virtual object to perform at least one capture operation on the virtual pet when the remaining duration indicated by the duration indication information is less than or equal to the first value.

In some embodiments, the control module 1830 is configured to: display, in response to a press operation on the capture control, a crosshair for the capture prop consumed in this capture operation; control, in response to a drag operation for the capture control, a position of the crosshair to change, the drag operation starting from a press position of the press operation, and the position of the crosshair being associated with a real-time position of the drag operation; display, when the crosshair hits the virtual pet, a first capture probability for the virtual pet, the first capture probability being a probability of successfully capturing the virtual pet in this capture operation; and control, in response to the end of the drag operation, the virtual object to throw the capture prop consumed in this capture operation toward the virtual pet, so as to capture the virtual pet at the first capture probability.

In some embodiments, the control module 1830 is configured to transmit an obtaining request in response to the end of the first trigger operation, the obtaining request including operation information of the first trigger operation, and the obtaining request being configured for requesting to obtain the quantity of capture operations generated by the first trigger operation.

According to the technical solutions provided in the embodiments of this application, in view of the problem of low capture efficiency caused by performing an operation for a capture control during each capture in the related art, a single operation (e.g., first trigger operation) for the capture control can generate consecutive capture operations for a virtual pet. This application eliminates the need to repeatedly perform operations for the capture control, simplifies operations, and improves the efficiency of capturing the virtual pet.

When the apparatus provided in the foregoing embodiments implements functions thereof, it is illustrated with an example of division of each functional module. In actual application, the function distribution may be finished by different functional modules according to requirements. To be specific, a content structure of a device is divided into different functional modules, to implement all or some of the functions described above. In addition, the apparatus provided in the foregoing embodiments belongs to the same conception as the method embodiments. For a specific implementation process thereof, refer to the method embodiments. Details are not described herein again.

FIG. 19 is a structural block diagram of a terminal device 1900 according to an embodiment of this application. The terminal device 1900 may be a terminal device in the computer system shown in FIG. 1, and is configured to implement the virtual object control method provided in the foregoing embodiments.

Specifically, the terminal device 1900 usually includes a processor 1901 and a memory 1902.

The processor 1901 may include one or more processing cores, for example, a 4-core processor or an 8-core processor. The processor 1901 may be implemented in at least one hardware form of digital signal processing (DSP), a field programmable gate array (FPGA), and a programmable logic array (PLA). The processor 1901 may further include a main processor and a coprocessor. The main processor is configured to process data in an awakened state, also referred to as a central processing unit (CPU). The coprocessor is a low-power processor configured to process data in a standby state. In some embodiments, the processor 1901 may be integrated with a graphics processing unit (GPU). The GPU is configured to render and draw content that needs to be displayed on a display screen. In some embodiments, the processor 1901 may further include an AI processor. The AI processor is configured to perform computing operations related to machine learning.

The memory 1902 may include one or more computer-readable storage media. The computer-readable storage medium may be non-transient. The memory 1902 may further include a high-speed random access memory, and a non-volatile memory, for example, one or more disk storage devices and flash storage devices. In some embodiments, the non-transient computer-readable storage medium in the memory 1902 is configured to store a computer program. The computer program is configured to be possessed by one or more processors to implement the foregoing virtual object control method.

In some embodiments, the terminal device 1900 may further include a peripheral interface 1903 and at least one peripheral. The processor 1901, the memory 1902, and the peripheral interface 1903 may be connected through a bus or a signal cable. Each peripheral may be connected to the peripheral interface 1903 through a bus, a signal cable, or a circuit board. Specifically, the peripheral includes: at least one of a radio frequency circuit 1904, a display screen 1905, an audio circuit 1907, and a power supply 1908.

A person skilled in the art may understand that the structure shown in FIG. 19 constitutes no limitation on the terminal device 1900. The terminal device may include more or fewer components than those shown in the figure, or some components may be combined, or a different component deployment may be used.

In an exemplary embodiment, a computer-readable storage medium is further provided. The storage medium has a computer program stored therein. The computer program, when executed by a processor, implements the foregoing virtual object control method.

In some embodiments, the computer-readable storage medium may include: a read-only memory (ROM), a random access memory (RAM), a solid state drive (SSD), an optical disc, or the like. The RAM may include a resistance random access memory (ReRAM) and a dynamic random access memory (DRAM).

In an exemplary embodiment, a computer program product is further provided. The computer program product includes a computer program. The computer program is stored in a computer-readable storage medium. A processor of a terminal device reads the computer program from the computer-readable storage medium, and the processor executes the computer program, to cause the terminal device to perform the foregoing virtual object control method.

In this application, before collection of relevant data of the user and during the collection of the relevant data of the user, a prompt interface or a pop-up window may be displayed, or audio prompt information may be outputted. The prompt interface, the pop-up window, or the audio prompt information is configured for prompting the user that the relevant data of the user is currently searched for collection. In this way, in this application, only after a confirmation operation transmitted by the user for the prompt interface or the pop-up window is obtained, a relevant operation of obtaining the relevant data of the user is started to be performed. Otherwise (in other words, the confirmation operation transmitted by the user for the prompt interface or the pop-up window is not obtained), the relevant operation of obtaining the relevant data of the user is ended. To be specific, the relevant data of the user is not obtained. In other words, all user data acquired in this application is strictly processed according to the requirements of relevant national laws and regulations. The informed consent or independent consent of a subject of personal information is acquired with consent and authorization of the user within the scope of authorization of the laws and regulations and the subject of the personal information. Subsequent data use and processing, and collection, use, and processing of the relevant user data are required to comply with relevant laws, regulations, and standards of relevant countries and regions.

In the embodiments of this application, the term “module” or “unit” refers to a computer program having a predetermined function or a part of a computer program, and works together with another relevant part to achieve a predetermined objective, and may be all or partially implemented by using software, hardware (such as a processing circuit or a memory), or a combination of software and hardware. Similarly, one processor (or a plurality of processors or a plurality of memories) may be configured to implement one or more modules or units. In addition, each module or unit may be a part of an overall module or unit including the functionality of the module or unit. “Plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” indicates an “or” relationship between the associated objects. In addition, the operation numbers described herein merely exemplarily show a performance sequence of the operations. In some other embodiments, the operations may not be performed according to the sequence of the numbers. For example, two operations with different numbers may be performed simultaneously, or two operations with different numbers may be performed according to a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the spirit and principle of this application falls within the protection scope of this application.

What is claimed is:

1. A method for controlling a virtual object to capture virtual pets in a virtual environment performed by a computer device, the method comprising:
displaying a graphical user interface of a virtual environment, the virtual environment comprising a virtual object and a virtual pet;
receiving a first trigger operation on a capture control of the graphical user interface for the virtual pet, the first trigger operation being a continuous press operation configured for generating consecutive capture operations for the virtual pet;
determining a quantity of capture operations generated by the first trigger operation based on a press duration of the continuous press operation; and
controlling the virtual object to perform consecutive capture operations for the virtual pet until after the virtual pet is successfully captured by the virtual object or the quantity of capture operations generated by the first trigger operation is exhausted by the virtual object.

2. The method according to claim 1, further comprising at least one of the following:
continuously increasing the quantity of capture operations during execution of the first trigger operation; and
subtracting one from the quantity of capture operations upon each execution of a capture operation.

3. The method according to claim 1, wherein
a quantity of capture props consumed in an i^{th} capture operation among the consecutive capture operations is positively correlated with a value of i, i being a positive integer; or
a quantity of capture props consumed in each capture operation among the consecutive capture operations is positively correlated with the rarity of the virtual pet,
the capture props being configured to capture the virtual pet.

4. The method according to claim 1, further comprising:
controlling the virtual object to throw a capture prop toward the virtual pet once after the quantity of capture operations is increased during execution of the first trigger operation; or,
controlling the virtual object to throw the capture prop toward the virtual pet once prior to performing each capture operation among the consecutive capture operations.

5. The method according to claim 1, wherein the virtual object performs a different posture on each of the consecutive capture operations.

6. The method according to claim 1, further comprising:
when the virtual pet is successfully captured and the quantity of capture operations generated by the first trigger operation is not exhausted, returning capture props corresponding to remaining capture operations to an inventory of the virtual object.

7. The method according to claim 1, further comprising:
in response to the first trigger operation, displaying a plurality of virtual props owned by the virtual object, each virtual prop adopting a different capture manner to capture the virtual pet; and
in response to a selection operation for a first virtual prop among the plurality of virtual props, selecting the first virtual prop as the capture prop consumed in the consecutive capture operations, the selection operation being a swiping operation starting from a trigger position of the first trigger operation and ending at a position of the first virtual prop.

8. The method according to claim 1, wherein the controlling the virtual object to perform consecutive capture operations for the virtual pet comprises:
for an i^{th} capture operation, controlling the virtual object to perform the i^{th} capture operation on the virtual pet, i being a positive integer; and
when the i^{th} capture operation fails to capture the virtual pet, performing an (i+1)^{th} capture operation until the quantity of capture operations generated by the first trigger operation is exhausted or when the (i+1)^{th} capture operation successfully captures the virtual pet.

9. The method according to claim 1, further comprising:
before receiving the first trigger operation on the capture control:
receiving a second trigger operation on the capture control; and
in response to the second trigger operation, controlling the virtual object to perform one capture operation on the virtual pet.

10. The method according to claim 1, further comprising:
displaying duration indication information on the graphical user interface, the duration indication information indicating remaining duration for receiving the first trigger operation, wherein
the receiving a first trigger operation on the capture control for the virtual pet comprises:
receiving the first trigger operation when the remaining duration indicated by the duration indication information is greater than a first value.

11. The method according to claim 10, further comprising:
in response to the first trigger operation, updating the duration indication information with a preset duration when the quantity of capture operations is increased, the preset duration being a maximum value of the remaining duration, wherein
a third trigger operation is allowed to be received when the remaining duration indicated by the updated duration indication information is greater than the first value, and the third trigger operation is another trigger operation, different from the first trigger operation, for generating the consecutive capture operations for the virtual pet.

12. The method according to claim 10, further comprising:
in response to completion of the first trigger operation, controlling the virtual object to perform the consecutive capture operations on the virtual pet when the remaining duration indicated by the duration indication information is less than or equal to the first value.

13. The method according to claim 9, wherein the controlling the virtual object to perform one capture operation on the virtual pet comprises:
in response to a press operation on the capture control, displaying a crosshair for a capture prop consumed in this capture operation;
in response to a drag operation for the capture control, changing a position of the crosshair starting from a press position of the press operation in accordance with a real-time position of the drag operation;
when the crosshair hits the virtual pet, determining a first capture probability for the virtual pet, the first capture probability being a probability of successfully capturing the virtual pet in this capture operation; and
in response to the end of the drag operation, controlling the virtual object to throw a capture prop consumed in this capture operation toward the virtual pet in accordance with the first capture probability.

14. A computer device, comprising a processor and a memory, the memory having a computer program stored therein, and the computer program being loaded and executed by the processor and causing the computer device to implement a method for controlling a virtual object to capture virtual pets in a virtual environment including:
displaying a graphical user interface of a virtual environment, the virtual environment comprising a virtual object and a virtual pet;
receiving a first trigger operation on a capture control of the graphical user interface for the virtual pet, the first trigger operation being a continuous press operation configured for generating consecutive capture operations for the virtual pet;
determining a quantity of capture operations generated by the first trigger operation based on a press duration of the continuous press operation; and
controlling the virtual object to perform consecutive capture operations for the virtual pet until after the virtual pet is successfully captured by the virtual object or the quantity of capture operations generated by the first trigger operation is exhausted by the virtual object.

15. The computer device according to claim 14, wherein
a quantity of capture props consumed in an i^{th} capture operation among the consecutive capture operations is positively correlated with a value of i, i being a positive integer; or
a quantity of capture props consumed in each capture operation among the consecutive capture operations is positively correlated with the rarity of the virtual pet,
the capture props being configured to capture the virtual pet.

16. The computer device according to claim 14, wherein the virtual object performs a different posture on each of the consecutive capture operations.

17. The computer device according to claim 14, wherein the method further comprises:
in response to the first trigger operation, displaying a plurality of virtual props owned by the virtual object, each virtual prop adopting a different capture manner to capture the virtual pet; and
in response to a selection operation for a first virtual prop among the plurality of virtual props, selecting the first virtual prop as the capture prop consumed in the consecutive capture operations, the selection operation being a swiping operation starting from a trigger position of the first trigger operation and ending at a position of the first virtual prop.

18. The computer device according to claim 14, wherein the controlling the virtual object to perform consecutive capture operations for the virtual pet comprises:
for an i^{th} capture operation, controlling the virtual object to perform the i^{th} capture operation on the virtual pet, i being a positive integer; and
when the i^{th} capture operation fails to capture the virtual pet, performing an (i+1)^{th} capture operation until the quantity of capture operations generated by the first trigger operation is exhausted or when the (i+1)^{th} capture operation successfully captures the virtual pet.

19. The computer device according to claim 14, wherein the method further comprises:
before receiving the first trigger operation on the capture control:
receiving a second trigger operation on the capture control; and
in response to the second trigger operation, controlling the virtual object to perform one capture operation on the virtual pet.

20. A non-transitory computer-readable storage medium, having a computer program stored therein, the computer program being loaded and executed by a processor of a computer device and causing the computer device to implement a method for controlling a virtual object to capture virtual pets in a virtual environment including:
displaying a graphical user interface of a virtual environment, the virtual environment comprising a virtual object and a virtual pet;
receiving a first trigger operation on a capture control of the graphical user interface for the virtual pet, the first trigger operation being a continuous press operation configured for generating consecutive capture operations for the virtual pet;
determining a quantity of capture operations generated by the first trigger operation based on a press duration of the continuous press operation; and
controlling the virtual object to perform consecutive capture operations for the virtual pet until after the virtual pet is successfully captured by the virtual object or the quantity of capture operations generated by the first trigger operation is exhausted by the virtual object.
